(19) United States
(12) Patent Application Publication
(10) Pub. No.: US 2008/0122151 A1
(43) Pub. Date: May 29, 2008

(54) Levitation unit with a tilting function and levitation device

(75) Inventors: Masashi Ito, Komaki-shi (JP); Hisanobu Niwa, Komaki-shi (JP); Masaki Saito, Komaki-shi (JP)

Correspondence Address: OLIFF & BERRIDGE, PLC, P.O. BOX 320850, ALEXANDRIA, VA, 22320-4850, US

(73) Assignee: CKD CORPORATION, KOMAKI-SHI (JP)

(21) Appl. No.: 11/723,306

(22) Filed: Mar. 19, 2007

Related U.S. Application Data
(60) Provisional application No. 60/861,241, filed on Nov. 28, 2006.

(51) Int. Cl. F16C 32/06

(52) U.S. Cl. 269/20

(57) ABSTRACT

A rocking substrate 31 provided with a porous unit 41 is supported by a platform 21 by means of a spherical bearing. Furthermore, air is provided between the platform 21 and the rocking substrate 31 to allow the rocking substrate 31 and the porous unit 41 to rock along a spherical surface. This rocking allows the top surface 12a of an improved levitation unit 12 to tilt freely. When a wavy glass substrate is placed on the levitation device, the top surface 12a of the improved levitation unit 12 tilts, tracing the tilt of the substrate. Jetting air out in this state levitates the substrate, with its top surface 12a in the horizontal state, and allows the levitational force to be reliably applied to the substrate.

### FIELD OF THE INVENTION

The present invention relates to a levitation unit with a tilting function and a levitation device provided with such unit.

### BACKGROUND ART

Conventionally, a device for correcting positional shifts in glass substrates is used in liquid crystal panel manufacturing processes. Some of the various manufacturing processes require accurate positioning of the glass substrate, and thus before the substrate is sent to a processing step, the positional shifts that have occurred during prior processes and transfer steps are corrected. This operation is called alignment.

A levitation unit is often used in such devices for correcting positional shifts. The fact that air jetted out from the levitation unit is used to levitate the glass substrate, correcting the positional shift on a non-contact basis, prevents the problematic scratches that can result from sliding when the glass substrate is supported on a contact basis (see Japanese Patent Application No. 2004-241465).

As shown in FIG. 23, a large number of levitation units 71 are conventionally provided on a base 72. Furthermore, the individual levitation units 71 are positioned such that their top surfaces (the top surface of a porous body 74 described below) form a single plane. The air jetted out from the top surfaces of the levitation units 71 provides support to the glass substrate G at close intervals. As shown in FIG. 24, the levitation unit 71 is provided with a main body 73 and a porous body 74 provided on the top side of the main body 73. Air is supplied to the porous body 74 via a passage 75 formed inside the base 72 and an air passage 76 formed inside the main body 73, allowing the air to jet out from the top surface of the porous body 74.

### SUMMARY OF THE INVENTION

When the glass substrate G is supported on a non-contact basis, waviness occurs in the glass substrate G as shown in FIG. 23. That is, the areas of the glass substrate G located directly above the levitation units 71 receive the jetting air and form ridges, while the areas of the glass substrate G not located directly above the levitation units 71 form troughs because the effect of the air on these areas is weaker.

As shown in detail in FIG. 24, there is a gap between the glass substrate G and the levitation units 71 at the edges of the glass substrate G. Consequently, much of the air jetted out from the top surface of the levitation units 71 escapes to the outside through this gap, preventing sufficient levitational force from being applied to the glass substrate G. As a result, the glass substrate G contacts the corner of the top surface of the levitation units 71, losing the meaning of using the levitation units 71 for supporting the glass substrate G on a non-contact basis.

Note that in FIGS. 23 and 24, the waviness depicted in the glass substrate G is exaggerated for purposes of explanation. Furthermore, such waviness can occur not only in a glass substrate G but also in any thin plate-shaped workpiece.

One way to prevent the generation of waviness is to increase the number of levitation units provided. However, increasing their number increases the installation cost as well as the operation cost due to an increase in the volume of air consumed, making this option impractical.

Therefore, a primary object of the present invention is to provide a levitation unit that can ensure contact-free support of workpieces even at the edge of a wavy workpiece, and a levitation device provided with such a levitation unit.

A first levitation unit with a tilting function can be configured with a tilting function as described below. That is,

the levitation unit may be provided with a jetting surface from which pressurized gas jets out, and with

a rocking means that allows the jetting surface to be passively tilted, and

can support a workpiece free of contact with the jetting surface, by means of the pressurized gas jetting out from the jetting surface.

In this levitation unit, when an external force is applied to the jetting surface, the rocking means allows the jetting surface to tilt following the external force. Therefore, when the levitation unit supports a workpiece on a non-contact basis, the jetting surface tilts tracing the tilt of the workpiece when the workpiece is initially placed on the jetting surface, even if the workpiece itself has waviness. Then, when a pressurized gas is jetted out from the jetting surface, levitating the workpiece, the bottom surface of the workpiece remains roughly parallel to the jetting surface, ensuring that the levitational force from the jetting of the pressurized gas is reliably applied to the workpiece. Thus, positioning this levitation unit at the edge of the workpiece, where the pressurized gas tends to escape to the outside because of a tilt caused by the waviness of the workpiece, allows the workpiece to be reliably supported on a non-contact basis even at the edge. Note that the tilt in this case refers to a tilt relative to the original installation surface.

A preferred example of this first levitation unit with a tilting function could be one in which the rocking means is configured such that a rocking member having the jetting surface is supported on a platform via a spherical bearing.

In this rocking means, since supporting the rocking member with a spherical bearing allows the jetting surface to tilt freely, the jetting surface can be freely tilted in any direction without the use of a complicated structure.

In the preferred example, it is preferable to configure the spherical bearing by providing a concave spherical area on either the platform or the rocking member and a convex spherical area on the other, fitting these spherical surfaces together to support the rocking member on the platform, and having a pressurized gas be present between the rocking member and the platform.

With such a configuration, the pressurized gas present between the rocking member and the platform reduces the frictional resistance in the spherical bearing, allowing the jetting surface to smoothly tilt when even a minute external force is applied. Furthermore, since the platform is not in contact with the rocking member, no dust is generated when the jetting surface tilts, making the levitation unit ideal for installation in a clean room.

In the preferred example, it is further preferable to provide an elastic tube inside the platform and the rocking member for connecting these two members, and to supply the pressurized gas to the jetting surface through the elastic tube; and furthermore to form a deformable space around the elastic tube that allows the elastic tube to deform as the rocking member rocks.

In this configuration, the urging force of the elastic tube provided to connect the platform with the rocking member causes the rocking member to naturally return to its original position after the task of supporting a workpiece is finished. In this way, if the jetting surface is set such that it is horizontal in its initial position, during the next operation the workpiece can be safely placed on the jetting surface without the corner of the rocking member contacting the workpiece. Moreover, since a deformable space is formed around the elastic tube, the elastic tube can deform as the rocking member rocks, and thus does not prevent the jetting surface from tilting freely. Furthermore, since the pressurized gas is supplied to the jetting surface through the elastic tube, the entire volume of the pressurized gas is supplied to the jetting surface with no leakage in transit. This configuration allows a sufficient volume of pressurized gas to be supplied to the jetting surface, and also allows the volume of pressurized gas that must be supplied to the levitation unit to be reduced, leading to a lower operating cost.

A second levitation unit with a tilting function can be a levitation unit in which the pressurized gas jetting out from a jetting surface supports a workpiece free of contact with the jetting surface, and may be configured as described below. That is,

this levitation unit can be provided both with a rocking member provided with the jetting surface and in which either a convex spherical surface or a concave spherical surface, both of the spherical surfaces have the same radius of curvature, is formed on the side opposite the jetting surface, and with

a platform that forms the corresponding convex or concave spherical surface, and which supports the rocking member with the two spherical surfaces fitted together; wherein
the presence of a pressurized gas between the platform and the rocking member allows the rocking member to rock along its spherical surface, permitting the jetting surface to be passively tilted.

In this levitation unit, when an external force is applied to the rocking member or jetting surface, the rocking member rocks along its spherical surface following the external force, causing the jetting surface to tilt. Therefore, when the levitation unit is to support a workpiece on a non-contact basis, the jetting surface tilts in line with the tilt of the workpiece when the workpiece is first placed on the jetting surface, even if the workpiece itself has waviness. Then, from this state, when a pressurized gas is jetted out from the jetting surface, levitating the workpiece, the bottom surface of the workpiece remains roughly parallel to the jetting surface, ensuring that the levitational force from the jetting of the pressurized gas is reliably applied to the workpiece. Thus, positioning this levitation unit at the edge of the workpiece, where the pressurized gas tends to escape to the outside because of a tilt of the workpiece, allows the workpiece to be reliably supported on a non-contact basis even at the edge. Moreover, the fact that free tilting of the jetting surface is achieved by the spherical bearing and any frictional resistance from the spherical bearing is eliminated by the presence of the pressurized gas allows the same effects to be obtained as those obtained by the preferred example of the aforementioned first levitation unit with a tilting function.

A preferred example of the second levitation unit with a tilting function could be a configuration in which a platform channel is formed on the platform and a rocking member channel linked to the jetting surface is formed in the rocking member, with both of these channels having openings at the concave spherical surface and convex spherical surface, and these openings facing each other.

In this configuration, supplying a pressurized gas to the platform channel supplies the pressurized gas to both the spherical bearing and the jetting surface simultaneously. In this way, the route for supplying the pressurized gas to the levitation unit is singularized, thus simplifying the tubing structure.

In the preferred example, it is preferable to further form the opening of either the platform channel or rocking member channel to be larger in diameter at the opening (tapered and larger in diameter at the opening), such that the opening of the rocking member channel will not be blocked even when the rocking member is tilted.

This configuration prevents the blocking of the opening of the rocking member channel even when the rocking member is tilted. As a result, the pressurized gas can flow into the rocking member channel without being constricted and a sufficient volume of the pressurized gas can be supplied to the jetting surface.

In the configuration provided with the rocking member, it is preferable to provide a disengagement prevention means to prevent the rocking member from becoming disengaged from the platform.

The disengagement prevention means prevents the rocking member from becoming disengaged from the platform, which stabilizes the rocking of the rocking member and allows the rocking member to be held stably in the tilted state.

In the configuration provided with the rocking member, it is preferable to provide a rocking restriction means to restrict the rocking of the rocking member to a predetermined range.

Providing such a rocking restriction means restricts the rocking of the rocking member to a predetermined range, which stabilizes the rocking of the rocking member.

In the configuration provided with the rocking member, it is preferable to provide a cylindrical covering member on the outside of the rocking member such that the cylindrical covering member hides at least the top portion of the side surface of the platform.

In this configuration, since the cylindrical covering member hides the top portion of the side surface of the platform, the pressurized gas passing through the spherical bearing passes through the area between the side surface of the platform and the internal surface of the cylindrical covering member and is discharged from the opening formed between the side surface of the platform and the internal end area of the cylindrical covering member. Since this opening opens downward, the pressurized gas is also discharged downward, thus reducing the risk that the discharged pressurized gas may be blown onto the workpiece.

In this configuration, it is preferable to further configure the disengagement prevention means and the rocking restriction means with a concave area formed on the side surface of the platform and a disengagement prevention pin provided on the cylindrical covering member, the tip of which is loosely inserted into the concave area.

Providing such a disengagement prevention pin on the cylindrical covering member not only prevents the rocking member from becoming disengaged from the platform but also restricts the rocking of the rocking member. In other words, this pin alone can serve as both the disengagement prevention means and the rocking restriction means, thus reducing the number of parts needed and simplifying the configuration. Note that since the disengagement prevention pin is loosely inserted into the concave area, the rocking member itself is still able to rock.

In the configuration provided with the rocking member, it is preferable to provide a balance adjustment means that adjusts the weight balance of the rocking member in the horizontal direction.

When such a balance adjustment means is provided and the weight balance of the rocking member in the horizontal direction is adjusted such that the jetting surface is horizontal when no workpiece is being supported, the jetting surface naturally returns to its original position after the task of supporting a workpiece is finished. As a result, during the next operation, the workpiece can be safely placed on the jetting surface without the corner of the rocking member contacting the workpiece.

Note that in the configuration provided with the elastic tube, the rocking member was urged to return to its initial position by the elastic tube. In this case, by providing a balance adjustment means, it is possible to set the initial position to a position in which the jetting surface is horizontal.

A third levitation unit with a tilting function can be a levitation unit provided with a jetting surface from which a pressurized gas is jetted, in which the pressurized gas jetting out from this jetting surface supports a workpiece free of contact with the jetting surface, and may be configured as described below. That is,

this levitation unit can be provided with a rocking member having the jetting surface as well as a support member that is secured to an installation surface and supports the rocking member; wherein the supported part of the rocking member and the supporting part of the supporting member may be disposed inside a supporting space provided in either the rocking member or the supporting member, and the supported part and the supporting part can be configured such that the rocking member can freely rock, using as a reference the state in which the jetting surface is parallel to the installation surface of the support member; and wherein
the support member may be provided with a support member channel, the rocking member can be provided with a rocking member channel connected to the jetting surface, the support member channel may be connected to the rocking member channel inside the supporting space, and a sealing means can be provided to prevent the pressurized gas from leaking from the supporting space.

In this levitation unit, the rocking member rocks by means of an external force, and the jetting surface on its top surface tilts from the reference position following the external force. Therefore, when the levitation unit supports a workpiece on a non-contact basis, the jetting surface tilts tracing the tilt of the workpiece when the workpiece is placed on the jetting surface, even if the workpiece itself has waviness. Then, from this state, when a pressurized gas is jetted out from the jetting surface, levitating the workpiece, the bottom surface of the workpiece remains roughly parallel to the jetting surface, ensuring that the levitational force from the jetting of the pressurized gas is reliably applied to the workpiece. Thus, positioning this levitation unit at the edge of the workpiece, where the pressurized gas tends to escape to the outside because of a tilt caused by the waviness of the workpiece, allows the workpiece to be reliably supported on a non-contact basis even at the edge.

Additionally, even if the pressurized gas flows into the supporting space when the pressurized gas supplied to the supporting member channel is introduced into the rocking member channel, the sealing means prevents the pressurized gas from leaking outside the supporting space. This prevents the pressurized gas supplied to the support member channel from being wasted by being discharged to the outside without being jetted from the jetting surface.

A preferred example of the third levitation unit with a tilting function could be a configuration in which either the supporting part or the supported part is formed into a spherical surface while the other is formed into a mortar shape with a tapered surface, and the contact between the spherical surface and the tapered surface allows the rocking member to rock freely.

In this configuration, the contact between the spherical surface and the tapered surface allows the rocking member to be rockably supported by the supporting member. In this way, when the rocking member rocks against the supporting member, the sliding resistance that occurs between the supporting part and the supported part is reduced compared to a case in which planar contact is present.

Another preferred example of the third levitation unit with a tilting function could be one in which either the supporting part or the supported part is formed into the spherical surface of a spherical member while the other is formed into a mortar shape with a tapered surface, wherein the contact between the spherical surface and the tapered surface allows the rocking member to rock freely, and wherein the sealing means contacts the spherical surface of the spherical member at a position different from the contact position between the spherical surface and the tapered surface, such that the contact between the sealing means and the spherical surface of the spherical member enables the sealing means to possess both a sealing function and the function of holding the rocking member.

In this configuration, the contact between the spherical surface and the tapered surface allows the rocking member to be slidably supported by the supporting member. In this way, when the rocking member slides against the supporting member, the sliding resistance that occurs between the supporting part and the supported part is reduced compared to a case in which planar contact is present. Furthermore, the sealing means not only prevents the pressurized gas inside the supporting space from escaping to the outside but also has a function for supporting the rocking member, with the result that the rocking member is more stably supported.

In this good example, it is preferable to provide the contact position between the sealing means and the spherical surface of the spherical member on the side vertically opposite the contact position between the tapered surface and the spherical surface, across the spherical member.

In this configuration, the rocking member is supported on one side of the spherical member by the contact with the tapered surface, and on the other side its supported state is maintained by the contact with the sealing means, with the result that the rocking member is more stably supported.

In both of the aforementioned configurations of the third levitation unit with a tilting function, it is preferable to configure the rocking member and the supporting member with their centers aligned along a single line in the vertical direction, and to form the supporting space with the center line at its center.

Such a configuration prevents the rocking member from being supported by the supporting member in a biased state, and allows the rocking member to be supported in a well-balanced manner.

In both of the aforementioned configurations of the third levitation unit with a tilting function, it is preferable to provide the supporting member channel and the rocking member channel on a single straight line extending in the vertical direction.

Such a configuration allows the channels to be easily manufactured since they are linear, and the fact that the two channels together form a single straight line allows the pressurized gas to flow through them smoothly.

In this configuration, it is further preferable to form the inlet-side opening of the rocking member channel to be larger than the outlet-side opening of the supporting member channel.

When the openings are formed in this way, it is possible to position the outlet-side opening of the supporting member channel inside the inlet-side opening of the rocking member even when the rocking member is tilted, thus preventing the opening from becoming blocked and ensuring a smooth flow of the pressurized gas.

In any of the configurations of the third levitation unit with a tilting function, it is preferable to make the sealing means an O-ring that closely contacts the spherical surface of the spherical member, and to position this O-ring such that the pressure from the pressurized gas inside the supporting space is applied to the O-ring from inside the ring.

In this configuration, since the pressure from the pressurized gas is applied to the O-ring from inside the ring, the O-ring tries to expand as a result. Therefore, the force that tries to contract the O-ring back inward, i.e., the force that presses on the spherical surface, does not easily increase. As a result, even when the O-ring receives the pressure of the pressurized gas, the sliding resistance that occurs between it and the spherical member is prevented from increasing.

Alternatively, it is also acceptable to make the sealing means an O-ring that closely contacts the spherical surface of the spherical member, to configure the rocking member using an upper member and a lower member, and then, by integrating the two members, to form the supporting space and the ring-shaped groove for installing the O-ring.

With such a configuration, even when the rocking member is configured using multiple members, i.e., the upper member and the lower member, a single O-ring can be used as a seal between all three members, i.e., the upper member, the lower member, and the spherical member. This configuration eliminates the need for installing multiple O-rings, reducing the manufacturing cost.

In this case, it is preferable to configure the supporting space such that it completely houses the spherical member, and to provide inside the supporting space a contact surface that contacts the spherical surface of the spherical member on the side vertically opposite the contact position between the spherical surface of the spherical member and the tapered surface.

In this configuration, because the spherical member contacts the contact surface on the side opposite from where it rockably supports the rocking member, the spherical member is more stably supported.

A fourth levitation unit with a tilting function can be a levitation unit provided with a jetting surface from which a pressurized gas is jetted, in which the pressurized gas jetting out from this jetting surface supports a workpiece free of contact with the jetting surface, and may be configured as described below. That is,

this levitation unit can be provided with a supporting member that has a spherical member, on the bottom end of which an axle extending in the vertical direction is provided, the axle being provided with a securing part that is secured to an installation surface, and which also has a supporting member channel that opens at the spherical surface of the spherical member; and is also provided with

a rocking member provided with a jetting part having the jetting surface on its top surface, containing a supporting space for housing the spherical member, with the opening of an insertion hole connecting the interior of the supporting space to the outside provided face down with the axle being inserted into the insertion hole, and a downward-facing, mortar-shaped tapered surface provided in the top part of the supporting space with the tapered surface contacting the spherical surface of the spherical member; and further provided with a rocking member channel that is connected to the jetting part and opens at the surface that forms the supporting space; wherein
the contact between the tapered surface and the spherical member allows the rocking member to be rockably supported by the supporting member; and

an O-ring for preventing the pressurized gas inside the supporting space from leaking can be provided on the internal perimeter of the insertion hole with the O-ring installed in a ring-shaped groove to provide a sidewall surface that contacts the inside of the O-ring.

In this levitation unit, since the pressure from the pressurized gas is applied to the O-ring from the outside of the ring, the O-ring in response tries to contract inward, and this contracting force becomes a pressing force against the spherical surface of the spherical member as well as a pressing force against the sidewall surface. Because of this force distribution, the pressing force against the spherical surface is smaller than that of a configuration in which no sidewall surface is provided. As a result, even though the sliding resistance increases as the O-ring receives the pressure from the pressurized gas, this increase is limited.

A fifth levitation unit with a tilting function can be a levitation unit provided with a jetting surface from which a pressurized gas is jetted, in which the pressurized gas jetting out from this jetting surface supports a workpiece free of contact with the jetting surface, and may be configured as described below. That is,

this levitation unit can be provided with a supporting member that has a spherical member, on the bottom end of which an axle extending in the vertical direction is provided, the axle being provided with a securing part that is secured to an installation surface, and which also has a supporting member channel that opens at the spherical surface of the spherical member; and also provided with

a rocking member provided with a jetting part having the jetting surface on its top surface, containing a supporting space for housing the spherical member, with the opening of an insertion hole connecting the interior of the supporting space to the outside provided face down with the axle being inserted into the insertion hole, and a contact area that can contact the bottom area of the spherical surface of the spherical member provided on the inside bottom of the supporting space; and further provided with a rocking member channel that is connected to the jetting part and opens at the surface that forms the supporting space; wherein

the rocking member can be provided with an O-ring that is positioned horizontally in a position higher than the center of the spherical surface inside the supporting space and that may prevent the pressurized gas from leaking out of the space between the spherical member and the rocking member; and wherein

the contact between the O-ring and the top part of the spherical surface of the spherical member allows the rocking member to be rockably supported by the supporting member.

In this levitation unit, when the pressurized gas reaches the supporting space via the supporting member channel, the O-ring deforms in the expansion direction, i.e., the direction in which the tightening force on the spherical surface weakens. Moreover, the O-ring is placed in a position where it contacts the spherical surface at a position higher than the center of the spherical surface of the spherical member. When the pressure of the pressurized gas inside the supporting space increases, a force occurs that lifts the rocking member from the supporting member. However, since this force is not applied in the direction that compresses the O-ring, the pressing force on the spherical surface of the spherical member does not increase.

As explained above, in addition to the characteristic in which the pressure from the pressurized gas is applied to the internal perimeter of the O-ring, the positional characteristic in which the O-ring is positioned higher than the center of the spherical surface prevents the sliding resistance generated between the O-ring and the spherical surface of the spherical member from increasing further, even when the pressure from the pressurized gas is received. Therefore, even when the pressure of the pressurized gas inside the supporting space is increased, the rocking member is still allowed to rock smoothly.

Moreover, when the pressure inside the supporting space is increased as described above, the force trying to move the rocking member upward relative to the supporting member is borne by the contact between the contact area and the bottom part of the spherical surface of the spherical member, enabling the O-ring to maintain its sealing effect. During the stage before the pressure inside the supporting space increases, the contact area need not necessarily contact the bottom part of the spherical surface of the spherical member, but at least when the pressure is increased, the contact area needs to be in contact with the bottom part of the spherical surface of the spherical member before the sealing effect of the O-ring is lost.

Note that it is preferable to form the contact area as a tapered surface formed as an upward-facing mortar shape. It is also preferable to house the O-ring in a ring-shaped groove formed on the rocking member. Furthermore, from the viewpoint of suppressing air vibration, it is preferable to maintain the supporting member and the rocking member such that they do not contact each other at any location above the O-ring inside the supporting space.

A sixth levitation unit with a tilting function can be a levitation unit provided with a jetting surface from which a pressurized gas is jetted, in which the pressurized gas jetting out from this jetting surface supports a workpiece free of contact with the jetting surface, and may be configured as described below. That is,

this levitation unit can be provided with a rocking member having the jetting surface and a supporting member that supports the rocking member; wherein

a spherical member provided in the supporting member may be housed inside a supporting space provided in the rocking member, and

the supporting space can be provided internally with a ring-shaped sealing means that seals the space between the internal surface forming the supporting space and an area higher than the center of the spherical surface of the spherical member by contacting both, and that also allows the supporting member to rockably support the rocking member through this contact; and wherein

the supporting member may be provided with a supporting member channel that opens at a position higher than the contact area between the spherical member and the sealing means, and the rocking member can be provided with a rocking member channel, one end of which is connected to the jetting surface while the other end opens at the internal surface forming the supporting space and is connected to the opening of the supporting member channel via the supporting space.

In this levitation unit, the rocking member is supported by the supporting member via the sealing means. When an external force is applied to this rocking member, the spherical surface of the spherical member slides against the sealing means, causing the rocking member to rock. Consequently, the jetting surface located on the top surface of the rocking member tilts from the reference position following the external force. This means that this levitation unit also allows the jetting surface to tilt tracing the tilt caused by waviness in the workpiece, thus supporting the workpiece reliably on a non-contact basis. Note that when the pressurized gas supplied to the supporting member channel is introduced into the rocking member channel via the supporting space, the pressure from the pressurized gas is applied to the sealing means, which tries to expand outward in response. This expansion increases the pressing force with which the sealing means presses the spherical surface of the spherical member and the internal surface forming the supporting space, improving the sealing effect of the sealing means when the pressurized gas is being supplied.

Furthermore, this configuration which rockably supports the rocking member on the supporting member as described above causes the spherical surface of the spherical member to contact the sealing means provided inside the supporting space and supports the rocking member through this sealing means alone; thus, it can be considered an extremely simple configuration. Furthermore, no high-precision processing is required. Therefore, this configuration reduces the cost compared to a configuration that allows the rocking member to rock freely by supporting the top and bottom of a spherical member with tapered surfaces, which requires high precision in both processing and assembly.

A seventh levitation unit with a tilting function can be a levitation unit provided with a jetting surface from which a pressurized gas is jetted, in which the pressurized gas jetting out from this jetting surface supports a workpiece free of contact with the jetting surface, and may be configured as described below. That is,

this levitation unit can be provided with a rocking member having the jetting surface and a supporting member that supports the rocking member; wherein

a spherical member provided in the rocking member may be housed inside a supporting space provided in the supporting member, and

the supporting space can be provided internally with a ring-shaped sealing means that seals the space between the internal surface forming the supporting space and an area lower than the center of the spherical surface of the spherical member by contacting both, and that allows the supporting member to support the rocking member through this contact; and wherein

the rocking member may be provided with a rocking member channel, one end of which is connected to the jetting surface while the other end opens at a position lower than the contact area between the spherical member and the sealing means, and the supporting member can be provided with a supporting member channel that is connected to the other opening of the rocking member channel via the supporting space.

In this levitation unit, the technical concept of rockably supporting the rocking member by the contact between the sealing means and the spherical member inside the supporting space is the same as that in the aforementioned sixth levitation unit with a tilting function, with the difference being that the rocking member is provided with the spherical member and the supporting member is provided with the supporting space. The characteristic in which the pressure of the pressurized gas tries to expand the sealing means outward when the pressurized gas supplied to the supporting member channel is introduced into the rocking member channel via the supporting space is also the same. Thus, the seventh levitation unit with a tilting function provides the same effects as the aforementioned sixth levitation unit with a tilting function.

A preferred example of the sixth and seventh levitation units with a tilting function could be a configuration provided with a contact member that contacts the spherical surface on the side vertically opposite the contact position between the sealing means and the spherical surface of the spherical member, and with a pressing means for pressing the contact member against the spherical surface.

According to this configuration, the rocking member is supported by the contact between the sealing means and either the top or bottom of the spherical member, and additionally, the other end of the spherical member contacts the contact member, with the result that the spherical member is held in a stable state. Furthermore, the fact that the pressing force of the pressing means is applied to the contact member results in a more reliably maintained contact state between the contact member and the spherical member. As a result, the spherical member can be held stably, thus helping to support and stabilize the rocking member.

Another preferred example of the sixth and seventh levitation units with a tilting function could be configured as described below. That is,

the levitation unit can be provided with the supporting space by forming a concave housing area in either the rocking member or the supporting member; wherein

the supporting member or rocking member having the spherical member may be provided with an axle that extends in the vertical direction from the spherical member to the outside of the concave housing area via the opening of the concave housing area,

the axle may be threaded through at least two washers, and an urging means for urging both washers in the axis direction of the axle can be provided between the first washer, which contacts the spherical member in the internal circumferential edge of an insertion hole going through the axle, and the second washer, which is adjacent to the first washer; and wherein

a ring-shaped mounting groove may be formed on the perimeter surface that forms the concave housing area, and a snap ring that keeps the first washer in contact with the spherical member can be provided in the mounting groove.

According to this configuration, the rocking member is supported by the contact between the sealing means and either the top or bottom of the spherical member, and additionally, the other end of the spherical member contacts the first washer, with the result that the spherical member is held in a stable state. Furthermore, the fact that the urging force of the urging means causes the first washer to press against the spherical surface results in a more reliably maintained contact state between the first washer and the spherical member. As a result, the spherical member can be held stably, thus helping to support and stabilize the rocking member.

Additionally, the fact that the snap ring by itself can maintain the first washer in contact with the spherical member reduces the number of required parts compared to a configuration in which bolts are used to fasten a blocking member. This also helps reduce cost. Of course, using the snap ring alone would result in looseness between the ring and its mounting groove, causing the problem of unstable contact between the washer and the spherical member. For this reason, in the present configuration, the second washer is provided between the snap ring and the first washer and an urging means is additionally provided between the two washers. The urging force of this urging means is applied to the snap ring via the second washer, thereby preventing looseness from occurring.

In both of the aforementioned good examples, the pressing means or the urging means should preferably be a plate spring, and more preferably a wave washer. Since a plate spring is formed from a thin plate, it can simplify the configuration of the levitation unit and contribute to size reduction.

In both of the aforementioned configurations of the sixth and seventh levitation units with a tilting function, it is preferable to form a circular seal-mounting groove for mounting the sealing means on the bottom surface forming the supporting space, to configure the outer diameter of the sealing means to be the same as the diameter of the seal-mounting groove, and to configure the sealing means housed in the seal-mounting groove to be in contact with both the bottom and side surfaces forming the seal-mounting groove.

According to this configuration, there is no need to form a mounting groove for mounting a sealing means along the perimeter direction on the internal circumferential surface forming the supporting space, which simplifies the process of making the mounting groove. Moreover, since the installation of the sealing means is accomplished by simply mounting a sealing means having the same outer diameter as the seal-mounting groove in the groove, the work required is quite simple.

In both of the aforementioned configurations of the sixth and seventh levitation units with a tilting function, the sealing means should preferably be an O-ring.

Since O-rings are inexpensive and can be easily obtained, their use helps reduce cost.

In both of the aforementioned configurations, it is preferable to form the jetting surface from a porous body.

With such a configuration, since the pressurized gas is jetted out from the surface of the porous body, the throttling effect of the porous body on the pressurized gas passing through it generates hydrostatic pressure as well. Moreover, a porous body can more uniformly generate hydrostatic pressure between it and the workpiece compared to a throttling channel. This allows the workpiece to be held more stably on a non-contact basis.

The first levitation device can be provided with a large number of levitation units and may support a thin plate-shaped workpiece on a non-contact basis by means of a pressurized gas jetting out from the jetting surfaces of the levitation units, and on the four corners or edges of the levitation device, as viewed in a plan view diagram, can be provided any of the aforementioned levitation units with a tilting function among the multiple levitation units.

When a workpiece is levitated, waviness in the workpiece normally allows the pressurized gas to escape to the outside at the edges of the workpiece, allowing the workpiece to contact the levitation device. In contrast, the levitation device according to the present invention is provided with levitation units with a tilting function on its edges, ensuring that the workpiece can be reliably supported on a non-contact basis even at its edges. Since the four corners are the areas from which the pressurized gas is most likely to escape, providing levitation units with a tilting function in just these locations is sufficient to support the workpiece on a non-contact basis more reliably than with a conventional device. Furthermore, since levitation units with a tilting function are provided on only the four corners or edges, they do not significantly increase the cost of the levitation device.

The second levitation device can be provided with multiple levitation units and may support a thin plate-shaped workpiece on a non-contact basis by means of a pressurized gas jetting out from the jetting surfaces of the levitation units, and all of the multiple levitation units can be provided as any of the aforementioned levitation units with a tilting function.

Reducing the number of levitation units from those used in conventional levitation devices increases the deflection of the workpiece between the levitation units. However, the levitation device according to the present invention uses levitation units with a tilting function for all its levitation units, thus ensuring that the workpiece can be reliably supported on a non-contact basis, even when the deflection increases. Reducing the number of levitation units reduces the volume of pressurized gas that must be supplied to the levitation device, thereby reducing the operating cost. Furthermore, the height of the jetting surface of each levitation unit can be easily adjusted during the installation of the levitation units in the levitation device. Moreover, the size of the workpieces whose positional shift must be corrected varies from small to large, and using levitation units with a tilting function for all of the levitation units makes it possible to support even a small workpiece reliably on a non-contact basis.

The above and other objects, features, and advantages of the present invention will be apparent from the following description when taken in conjunction with the accompanying drawings which illustrate preferred embodiments of the present invention by way of example.

### DESCRIPTION OF THE PREFERRED EMBODIMENTS

### First Embodiment

The first embodiment of the present invention will be explained below, referencing drawings. Note that FIG. 1 is a cross-sectional diagram (cross-sectional diagram along line A-A in FIG. 2) of a levitation unit with a tilting function; FIG. 2 is a perspective diagram of a levitation unit with a tilting function; FIG. 3 is a schematic diagram illustrating the process from placing a glass substrate on a device to its levitation; and FIG. 4 is a plan view illustrating the state in which the positional shift of a glass substrate has been corrected. Hereafter, “top/bottom” means the vertical direction.

As shown in FIG. 4, a device that corrects the positional shift of a glass substrate G, i.e., a workpiece, is provided with a levitation device that supports the glass substrate G on a non-contact basis. The levitation device is provided with a base 2, not shown in this figure, and multiple levitation units are installed on this base 2. In the present embodiment, the individual levitation units 1 are positioned both lengthwise and widthwise and, more specifically, in a grid shape with equal intervals. Note that the number of levitation units 1 to be installed can be appropriately increased or decreased depending on the size of the target glass substrate G and its propensity to flex. The levitation units 1 consist of two types of levitation units. One type is the ordinary levitation unit 11 that has been conventionally available while the other type is a levitation unit 12 with a tilting function (hereafter referred to as an “improved levitation unit 12”).

Here, if only ordinary levitation units 11 are used to support the glass substrate G on a non-contact basis, the glass substrate G would problematically contact the levitation device at the front, back, left, and right edges shown in FIG. 4. Therefore, improved levitation units 12 are positioned at these front, back, left, and right edges.

Additionally, the individual levitation units 1 are positioned such that their top surfaces form a single plane. Then, the air jetted out from the top surfaces of the individual levitation units 1 supports the glass substrate G at close intervals. Multiple correction rollers S are provided around the glass substrate G to correct positional shifts. Driving devices not shown in the figure synchronously move these correction rollers S in the direction that contacts or separates from the side surface of the glass substrate G (the direction of the arrows shown in FIG. 4) to correct the positional shifts.

Next, the configuration of the improved levitation unit 12 will be explained in detail. Note that the basic configuration of the ordinary levitation unit 11 is the same as that of a conventional levitation unit, with the only difference being that the top surface of the ordinary levitation unit 11 is configured to form a single plane with the top surface 12a of the improved levitation unit 12 as described above. Therefore, detailed explanation of the ordinary levitation unit 11 will be omitted.

As shown in FIGS. 1 and 2, the improved levitation unit 12 is provided with a platform 21 that has a circular shape when viewed in a plan view diagram. The center line passing through the center of the circle in the vertical direction is used as the center line of the entire improved levitation unit 12, and the various components and parts comprising the improved levitation unit 12, described below, are installed using this center line as the reference. The platform 21 is provided on its top surface 21a with a concave sphere 23 that forms a concave spherical surface. The platform 21 is also provided internally with a first channel 24 that acts as a base channel. The first channel 24 is formed such that one of its ends opens at the center of the concave sphere 23 while the other end opens at a bottom surface 21b. An opening 24a of the first channel 24, which opens at the concave sphere 23, is tapered and larger in diameter at the opening. Meanwhile, an O-ring 26 is provided around an opening 24b that opens at the bottom surface 21b.

The platform 21 is directly placed on the base 2 and secured to the base 2 with an appropriate securing means. An air channel 3 that opens at the top surface 2a of the base 2 is formed in the base 2, and the platform 21 is placed such that the opening of this air channel 3 is aligned with the opening 24b of the first channel 24. As a result, air supplied from outside the base 2 and passing through the air channel 3 is supplied to the first channel 24. Since the O-ring 26 seals the space between the bottom surface 21b of the platform 21 and the top surface 2a of the base 2, no air leaks out from this space.

The platform 21 is provided on its concave sphere 23 with a rocking substrate 31, which forms a larger circle than the platform 21 as viewed in a plan view diagram. The rocking substrate 31, together with the porous unit 41 described below, forms a rocking member. The top surface 31a of the rocking substrate 31 is formed to be flat. In contrast, its bottom surface, i.e., the surface facing the platform 21, is formed as a convex sphere 33 that forms a convex spherical surface, and this convex area is positioned such that it is coupled with the concave area of the concave sphere 23 of the platform 21. The convex sphere 33 is formed such that its radius of curvature is the same as the radius of curvature of the concave sphere 23. Therefore, the convex area of the convex sphere 33 and the concave area of the concave sphere 23 fit into each other.

The rocking substrate 31 is housed inside the hollow part of a cylindrical cover 34 having an inner diameter matching the outer diameter of the rocking substrate 31. As described above, since the rocking substrate 31 has a larger outer diameter than the platform 21 as viewed in a plan view diagram, this cylindrical cover 34 covers the rocking substrate 31 as well as the perimeter of the platform 21. Additionally, the cylindrical cover 34 is secured to the rocking substrate 31 by means of bolts 36, such that its top surface 34a forms a single plane with the top surface 31a of the rocking substrate 31.

Furthermore, a second channel 37 is formed inside the rocking substrate 31. The second channel 37, together with a third channel 47 described below, comprises the rocking member channel. The second channel 37 is formed such that one of its ends opens at the center of the top surface 31a of the rocking substrate 31 while the other end opens at the center (the peak area) of the convex sphere 33. The opening 37a of the second channel 37 at the convex sphere 33 is formed to be small enough to remain within the range of the opening 24a of the first channel 24 even when the rocking substrate 31 rocks as described below.

Here, the rocking substrate 31 is configured so as to not become disengaged from the platform 21. This configuration is explained below. In the lower part of the cylindrical cover 34, the internal surface 34b faces the side surface 21c of the platform 21, and furthermore, a pair of throughholes 38 going through the cylindrical cover 34 are formed in the lower part of the cylindrical cover 34, on opposing sides. Then, securing pins 39 are press-fitted into these throughholes 38 from the side of the outer surface 34c of the cylindrical cover 34, and are secured to the cylindrical cover 34 such that they do not protrude beyond the external surface 34c of the cylindrical cover 34. Meanwhile, a pair of concave areas 27 are formed on the side surface 21c of the platform 21 and positioned on opposing sides. The tips of the securing pins 39 are loosely inserted into these concave areas 27. That is, the opening areas of the concave areas 27 are formed to be slightly larger than the cross sections of the securing pins 39, and the securing pins 39 are inserted into the concave areas 27 with some play. This allows the rocking substrate 31 and the cylindrical cover 34 to also have that much play but prevents them from disengaging from the platform 21. Note that this play allows the rocking substrate 31 to tilt. These concave areas 27 and the securing pins 39 comprise a securing means as well as a rocking restriction means.

A porous unit 41 is provided on the top surface 31a of the rocking substrate 31 and secured to the rocking substrate 31 by means of bolts 42. The porous unit 41 is comprised of a unit main body 43 and a porous body 44. A housing groove 45 is formed on the top surface 43a of the unit main body 43, and the porous body 44 is housed inside this housing groove 45, protruding beyond the top surface 43a. Note that the distance from the top surface 44a of the porous body 44 to the bottom end of the convex sphere 33 is shorter than the radius of curvature of the convex sphere 33. A flow groove 46 is formed on the bottom surface of the housing groove 45. Furthermore, a third channel 47 is formed inside the unit main body 43. The third channel 47 is formed such that one of its ends opens at the bottom surface of the flow groove 46 while the other end opens at the center of the bottom surface 43b of the unit main body 43.

Additionally, the opening 47a at the bottom surface 43b of the unit main body 43 is smaller than the opening 37b of the second channel 37. Moreover, an O-ring 49 is installed, surrounding the opening 47a.

The porous body 44 is formed from a fluorine resin, such as a sintered trifluoride resin or a sintered tetrafluoride resin. When air is supplied to the flow groove 46, this air passes through the micropores in the porous body 44 and jets out from the top surface 44a. Note that, in addition to a fluorine resin, the porous body 44 can also be formed from a synthetic resin material such as a sintered nylon resin or a sintered polyacetal resin; a metal material such as sintered aluminum, sintered copper, or sintered stainless steel; a sintered carbon; a sintered ceramic, or the like.

In the improved levitation unit 12 thus configured, when air is supplied to the first channel 24 of the platform 21 via the air channel 3 of the base 2, this air is supplied to the porous body 44 by traveling from the first channel 24 through the second channel 37 of the rocking substrate 31, and then through the third channel 47 and the flow groove 46 of the porous unit 41. Then, air is jetted out from the top surface 44a of the porous body 44, that is, the top surface 12a of the improved levitation unit 12. This jetting air generates a levitational force that levitates the glass substrate G placed on the top surface 12a of the improved levitation unit 12 and supports it on a non-contact basis. Note that in the present embodiment, the top surface 12a of the improved levitation unit 12 (the top surface 44a of the porous body 44) is the jetting surface.

Additionally, the air supplied to the first channel 24 also flows between the platform 21 and the rocking substrate 31, that is, between the concave sphere 23 and the convex sphere 33. This airflow generates an air film between the two members, eliminating the frictional resistance between them. In this way, the concave sphere 23 of the platform 21 and the convex sphere 33 of the rocking substrate 31 comprise a spherical bearing. Because of this spherical bearing, when an external force is applied to the rocking substrate 31 and the porous unit 41, the rocking substrate 31 and the porous unit 41 follow this force within the range of the aforementioned play, rotating along the concave sphere 23, and become tilted relative to the top surface 2a of the base 2. This is called a tracing movement. Note that the air flowing between the concave sphere 23 and the convex sphere 33 flows out from the outer perimeter of the concave sphere 23 and, after passing between the side surface 21c of the platform 21 and the internal surface 34b of the cylindrical cover 34, is discharged from the opening 13 located in the lower part of the levitation unit 12. Since this opening 13 opens downward, the air is also discharged downward.

Next, an explanation will be provided for the operations of a device that uses multiple levitation units 1, comprising the aforementioned improved levitation units 12 and ordinary levitation units 11, to correct the positional shifts of a glass substrate G. Out of these operations, the operation of supporting the glass substrate G on a non-contact basis will be explained in detail using the operation of the improved levitation unit 12 and based on FIG. 3. Note that FIG. 3 omits the cylindrical cover 34 for the ease of showing the operation.

As described above, in this positional shift correction device, multiple ordinary levitation units 11 and improved levitation unit 12 are provided on the base 2 (see FIG. 4). First, the glass substrate G is placed on the top surfaces of the individual levitation units 1 by a transfer means not shown in the figure.

Here, some degree of waviness has already been generated in the glass substrate G itself by the various types of processing applied to the substrate G, even before it is placed on the levitation device. Consequently, as shown in FIG. 3 (a), before the glass substrate G is placed on the levitation device, the substrate G and the top surface 12a of the improved levitation unit 12 are non-parallel with each other. When the glass substrate G is placed on the levitation device, a volume of air sufficient to generate an air film between the concave sphere 23 and the convex sphere 33, to reduce the frictional resistance, is supplied to the first channel 24. A tracing movement is made possible as a result. This supply of air causes air to also jet out from the top surface 12a of the improved levitation unit 12, but does not generate a levitational force sufficient to levitate the glass substrate G.

The glass substrate G is lowered by the transfer means and placed on the individual levitation units 1. Then, in the improved levitation unit 12, as shown in FIG. 3 (b), the rocking substrate 31 and the porous unit 41 rotate tracing the tilt of the glass substrate G and become tilted, and the glass substrate G is supported on a contact basis, with its bottom surface making planar contact with the top surface 12a of the improved levitation unit 12.

Next, air is supplied to each levitation unit 1 via the air channel 3 of the base 2, and that air is jetted out from the top surface of each levitation unit 1. Here, a volume of air sufficient to generate the levitational force required to levitate the glass substrate G is supplied. The glass substrate G is then levitated from the top surfaces of the individual levitation units 1 and is supported at close intervals by the levitational force without contacting the top surface. In the improved levitation units 12, as shown in FIG. 3 (c), the glass substrate G levitates, with the top surface 12a and its bottom surface (the surface facing the improved levitation unit 12) remaining roughly parallel to each other, and is supported in this state on a non-contact basis. As a result, the levitational force generated by the air jetting out of the top surface 12a of the improved levitation unit 12 is reliably applied to the glass substrate G, essentially eliminating the possibility that the glass substrate G could contact the top surface 12a. The improved levitation units 12 are provided in locations where the problem of contact would be caused by waviness in the glass substrate G, if ordinary levitation units 11 were used, that is, at the front, back, left, and right edges shown in FIG. 4; thus, they eliminate the problem of contact.

Afterwards, multiple correction rollers S provided around the glass substrate G correct any positional shifts. In this embodiment, since the use of the improved levitation units 12 has eliminated the problem of contact between the glass substrate G and the levitation units 1, the glass substrate G is never scratched during this positional shift correction.

As described in detail above, the present embodiment has the following superior effects.

According to the present embodiment, even if the top surface 12a of the improved levitation unit 12 and the glass substrate G are not parallel with each other because of waviness in the substrate G, the rocking substrate 31 and the porous unit 41 rotate tracing the tilt of the glass substrate G when the substrate G is placed on the top surface 12a of the improved levitation unit 12. This tracing movement causes the top surface 12a of the improved levitation unit 12 to tilt tracing the tilt of the glass substrate G, such that the improved levitation unit 12 supports the substrate G with the bottom of the substrate G making planar contact with the top surface 12a. From this state, air jetting from the top surface 12a causes the glass substrate G to levitate, with its bottom surface remaining roughly parallel to the top surface 12a, allowing the levitational force generated by the air jetting out to be reliably applied to the glass substrate G. By providing the improved levitation units 12 at the edges of the glass substrate G, that is, in locations where the air tends to escape to the outside because of the tilt in the glass substrate G, the substrate G can be reliably supported on a non-contact basis, even at its edges.

Furthermore, the fact that the improved levitation unit 12 can reliably apply the levitational force following the waviness in the glass substrate G as explained above makes reliable non-contact support possible even when the substrate G has significant waviness. It is also possible to allow significant waviness to occur in the glass substrate G by reducing the number of levitation units 1 installed (reducing the locations where the levitational force occurs). Such a configuration offers the side benefit of reducing cost by reducing the number of levitation units 1 to be installed.

In the present embodiment, supporting the rocking substrate 31 and the porous unit 41 by means of a spherical bearing comprised of the concave sphere 23 and the convex sphere 33 allows the top surface 12a of the improved levitation unit 12 to tilt freely. Consequently, the top surface 12a can be freely tilted in any direction without the use of a complicated configuration.

In the present embodiment, the air present between the platform 21 and the rocking substrate 31 eliminates the frictional resistance in the spherical bearing, allowing the top surface 12a of the improved levitation unit 12 to be smoothly tilted even when only a small external force is applied. Furthermore, since the platform 21 does not contact the rocking substrate 31, no dust is generated when the top surface 12a tilts, making the levitation unit ideal for installation in a clean room.

In the present embodiment, when air is supplied to the first channel 24, this air can be simultaneously supplied to both the space between the concave sphere 23 and the convex sphere 33 and the top surface 12a of the improved levitation unit 12. In this way, the air supply route to the improved levitation unit 12 is singularized, thus simplifying the tubing structure.

In the present embodiment, in the area where the first channel 24 is connected to the second channel 37, the opening 24a of the first channel 24 is tapered and larger in diameter at the opening, while the opening 37a of the second channel is small. Therefore, even when the rocking substrate 31 and the porous unit 41 tilt tracing the tilt of the glass substrate G, the opening 37a of the second channel 37 remains within the range of opening 24a. As a result, even when the rocking substrate 31 and the porous unit 41 tilt, the opening 37a of the second channel 37 will be neither partially nor completely blocked, preventing the air flow from being constricted and allowing a sufficient amount of air to be supplied to the top surface 12a of the improved levitation unit 12.

In the present embodiment, since the securing pins 39 are loosely inserted into the concave areas 27 of the platform 21, the rocking substrate 31 and the porous unit 41 are restricted in their tilting actions, and are also prevented from becoming disengaged from the platform 21. This stabilizes the tilting of the top surface 12a of the improved levitation unit 12 and allows it to be held stably in the tilted state. Moreover, the fact that the securing pins 39 fulfill both a disengagement prevention function and a rocking restriction function reduces the number of parts required, resulting in a simpler configuration.

In the present embodiment, since the cylindrical cover 34 covers the top portion of the side surface 21c of the platform 21, the air passing through the spherical bearing, that is, the space between the concave sphere 23 and the convex sphere 33, passes through the space between the side surface 21c of the platform 21 and the internal surface 34b of the cylindrical cover 34 and is discharged to the outside from the opening 13. Since this opening 13 opens downward, the air is also discharged downward, thus reducing the risk that the discharged air may be blown onto the glass substrate G.

### Second Embodiment

In the following explanation, only the areas that are different from the aforementioned first embodiment will be explained, referencing FIG. 5, with explanations of like parts omitted. Note that the various components and parts comprising the improved levitation unit 50, described below, are installed using the center line of the improved levitation unit 50 as the reference.

As shown in FIG. 5, an installation hole 51 that has a larger diameter than the channel diameter of the air channel 3 and that goes through the platform 21 vertically is formed inside the platform 21, and an installation groove 52 having the same groove diameter as the hole diameter of the installation hole 51 is formed on the bottom surface 43b of the unit main body 43. Note that an air channel 53, one end of which opens at the bottom surface of the installation groove 52 while the other end opens at the bottom surface of the flow groove 46, is formed inside the unit main body 43. Additionally, a housing hole 54 that has a larger diameter than the installation hole 51 and which goes through the rocking substrate 31 is formed inside the rocking substrate 31. An elastic tube 55 is then inserted from the installation hole 51 to the installation groove 52.

Both sides of the elastic tube 55 are bonded to the sidewalls of the installation hole 51 and the installation groove 52. This bonding hermetically seals the space between the elastic tube 55 and the sidewalls of the installation hole 51 and the installation groove 52. Furthermore, the elastic tube 55 positions the rocking substrate 31 and the porous unit 41 such that the top surface 50a of the levitation unit 50 is horizontal. The internal diameter of the elastic tube 55 is the same as the channel diameter of the air channel 3, and the air supplied from the air channel 3 passes through the elastic tube 55 and is supplied to the porous body 44. Here, in the present embodiment, the spherical bearing comprised of the concave sphere 23 and the convex sphere 33 comprises a sliding bearing. However, because of the aforementioned hermetic seal, no air leaks to the space between the two spheres 23 and 33.

A gap that functions as a deformation-allowance space is formed between the external perimeter surface of the elastic tube 55 and the wall of the housing hole 54. This gap permits the deformation of the elastic tube 55 accompanying the tracing movement that occurs when the glass substrate G is being supported, and also prevents the lower end of the housing hole 54 from colliding with the elastic tube 55 during the tracing movement. Therefore, the tracing movement is not hindered by the configuration provided with the elastic tube 55. Additionally, the energizing force of the elastic tube 55 causes the rocking substrate 31 and the porous unit 41 to return to their initial positions (positions where the top surface 50a is horizontal) after the task of supporting the glass substrate G is finished.

As described in detail above, the present embodiment provides the following superior effects.

According to the present embodiment, the energizing force of the elastic tube 55 causes the rocking substrate 31 and the porous unit 41 to naturally return to their initial positions after the task of supporting the glass substrate G is finished. As a result, during the next operation, the glass substrate G can be safely placed on the top surface 50a without the corner of the porous body 44, for example, contacting the glass substrate G. In this case, since a gap is formed between the external perimeter surface of the elastic tube 55 and the wall of the housing hole 54, the tracing movement is not hindered.

Additionally, air is supplied to the porous body 44 through the elastic tube 55 such that all of the air is supplied to the porous body 44 without any leaking out in transit. This allows a sufficient amount of air to be supplied to the porous body 44 and, furthermore, reduces the volume of pressurized gas that must be supplied to the levitation unit 50, leading to a lower operating cost.

Moreover, providing the elastic tube 55 adds a function for returning the rocking substrate 31 and the porous unit 41 to their initial positions, as well as a function for preventing air from leaking. In other words, these two functions can be added without complicating the configuration.

### Third Embodiment

Next, a third embodiment will be explained, referencing drawings. FIG. 6 is a cross-sectional diagram (cross-sectional diagram along line B-B in FIG. 7) of the levitation unit; FIG. 7 is a perspective diagram of the levitation unit; FIG. 8 is a cross-sectional exploded view of FIG. 6; FIG. 9 is a diagram illustrating the operation of an O-ring; and FIG. 10 is a schematic diagram illustrating the process from placing a glass substrate on a device to its levitation.

As shown in FIG. 6, the improved levitation unit 112 is provided with a support body 121 and a rocking body 131 that is rockably supported by the support body 121.

As shown in FIGS. 6 and 8, the support body 121 has an axle 122 that extends in the vertical direction and whose base is provided with a securing area 123. Additionally, the tip side of the axle 122 is provided with a sphere 124 that has a spherical surface and acts as a support member. The support body 121 is provided with an air passage 125 that acts as a support body channel and which opens at the top end of the sphere 124 and the bottom surface of the securing area 123 (hereafter, these openings are referred to as the “top opening” and “bottom opening”). The center line of the axle 122 is aligned with the vertical center line that passes through the securing area 123, the centers of the sphere 124 and the air passage 125, and is treated as the center line of the entire improved levitation unit 112. The various components and parts comprising the improved levitation unit 112, described below, are installed using this center line as the reference.

As shown in FIGS. 6 and 8, the rocking body 131 has a cylindrical outer shape, and is provided in the center of its bottom surface with a concave housing area 132 that is capable of housing the sphere 124. A step 132b is formed around the opening of the concave housing area 132. This step 132b houses an O-ring that acts as a sealing means.

An air passage 134 that acts as a rocking body channel and which has an opening (lower opening) at the top surface 132a of the concave housing area 132 is formed inside the rocking body 131. Note that the other opening (upper opening) of the air passage 134 will be described later. The lower opening of the air passage 134 is formed so as to have a larger diameter than the upper opening of the air passage 125 formed in the support body 121. Additionally, a tapered surface 135 that acts as a supported area is formed over the entire perimeter of the lower opening. The space surrounded by this tapered surface 135 is continuous with the space inside the concave housing area 132, and these spaces form a supporting space.

The concave housing area 132 houses the sphere 124 of the support body 121. In this housed state, the bottom of the sphere 124 protrudes from the bottom surface of the rocking body 131. Additionally, the top spherical surface 124a of the sphere 124 contacts the tapered surface 135, and based on this contact, the rocking body 131 is rockably supported by the support body 121.

Moreover, the top surface 131a of the rocking body 131 is formed flat, with a housing groove 136 formed thereon. A porous body 137 is housed inside the housing groove 136, protruding beyond the top surface 131a. The porous body 137 is formed from a fluorine resin, such as a sintered trifluoride resin or a sintered tetrafluoride resin. A flow grove 138 is formed on the bottom surface of the housing groove 136. The aforementioned air passage 134 formed in the rocking body 131 opens at the bottom surface of this flow grove 138, and this opening forms the upper opening. Consequently, the flow grove 138 is connected to the air passage 134 and the air passage 125 of the support body 121. When air is supplied via these air passages 125 and 134 to the flow grove 138, the air passes through the micropores in the porous body 137 and jets out from the top surface 137a. Note that, in addition to a fluorine resin, the porous body 137 can also be formed from a synthetic resin material such as a sintered nylon resin or a sintered polyacetal resin; a metal material such as sintered aluminum, sintered copper, or sintered stainless steel; a sintered carbon; a sintered ceramic, or the like.

A plate-shaped blocking member 141 that blocks the opening of the rocking body 131 is provided on its bottom surface. In the present embodiment, the rocking body is comprised of the rocking body 131 and the blocking member 141. The blocking member 141 is formed to have a plate shape and the same planar shape as the rocking body 131. The blocking member 141 is installed such that its top surface 141a joins the bottom surface of the rocking body 131, and is secured in this state to the rocking body 131 by means of securing means, such as bolts, not shown in the figure. Then, the space between the rocking body 131 and the blocking member 141 is sealed by the O-ring 133, provided on the side of the rocking body 131.

An insertion hole 143, into which the axle 122 and the securing area 123 of the support body 121 can be inserted, is formed in the center of the blocking member 141. When the blocking member 141 is assembled onto the rocking body 131, the axle 122 of the support body 121 is inserted into this insertion hole 143.

Furthermore, a ring-shaped groove 145 is formed around the insertion hole 143 on the top surface 141a of the blocking member 141. The internal perimetric edge of the ring-shaped groove 145 and the perimetric edge of the insertion hole 143 form a single plane 146, which is located lower than the top surface 141a of the blocking member 141. An O-ring 147 that acts as a sealing means is housed inside the ring-shaped groove 145, and contacts the spherical surface 124a of the sphere 124 of the support body 121. In this way, the O-ring 147 seals the space between the spherical surface 124a and the area around the insertion hole 143 of the blocking member 141.

As a result, the O-rings 133 and 147 prevent the air inside the rocking body 131 from leaking to the outside. Furthermore, by means of their tightening allowance, the O-rings 133 and 147 also fulfill the function of absorbing the dimensional errors that may have occurred when the various members of the rocking body 131 and the blocking member 141 were manufactured. Consequently, the need for high-precision processing of the individual members is removed.

Next, the operation of the improved levitation unit 112 having the aforementioned configuration will be explained.

The support body 121 is placed directly on the base 2 and secured at the securing area 123 to the base 2 by means of securing means, such as bolts, not shown in the figure. As shown in FIG. 6, an air channel 103 that opens at the top surface 2a of the base 2 is formed in the base 2, and the support body 121 is placed on the base 2, with the opening of the air channel 103 aligned with the lower opening of the air passage 125 of the support body 121. Thus, the air flowing through the air channel 103 is supplied to the air passage 125. Note that the space between the top surface 2a of the base 2 and the bottom surface of the securing area 123 is sealed by an O-ring not shown in the figure.

The air supplied to the air passage 125 passes through the air passage 134 of the rocking body 131 and the flow grove 138, and is supplied to the porous body 137. This air is then jetted out from the top surface 137a of the porous body 137, that is, the top surface 112a of the improved levitation unit 112. The jetting air generates a levitational force that levitates the glass substrate G placed on the top surface 112a of the improved levitation unit 112 and supports it on a non-contact basis. In the present embodiment, the top surface 112a of the improved levitation unit 112 (the top surface 137a of the porous body 137) is the jetting surface.

Note that although part of the air flowing out of the upper opening of the air passage 125 is introduced into the concave housing area 132 by passing through the space between the spherical surface 124a of the sphere 124 and the tapered surface 135, the sealing function of the O-rings 133 and 147 prevents this air from leaking to the outside.

When an external force is applied to the rocking body 131, the rocking body 131 and the blocking member 141 follow this force and tilt from the support body 121 while sliding at the contact area between the spherical surface 124a of the sphere 124 and the tapered surface 135. This tilt is measured using as the reference, the state in which the top surface 112a of the improved levitation unit 112 is parallel to the top surface 2a of the base 2, i.e., the surface on which the support body 121 is installed. In this case, the fact that the contact between the sphere 124 and the tapered surface 135 is a linear contact in the circumferential direction in which the tapered surface 135 is formed reduces the sliding resistance occurring between these two members. Additionally, the rocking body 131 tilts while also sliding at the contact area between the O-ring 147 and the spherical surface 124a of the sphere 124, and the sealing function between the O-ring 147 and the spherical surface 124a of the sphere 124 is maintained even while the rocking body 131 is tilting as well as after it has tilted.

Note that the improved levitation unit 112 uses a configuration in which the O-ring 147 is housed in the ring-shaped groove 145 as described above. The significance of this configuration will be explained below.

As shown in FIGS. 9 (a) and (b), the O-ring 147 receives on its outer sides the pressure of the air introduced into the concave housing area 132. As a result, the O-ring 147 tries to contract inward. In the case of a configuration in which the housing location for the O-ring 147 is provided only at a step area 149 as shown in FIG. 9 (a), the internal side of the O-ring 147 contacts only the spherical surface 124a of the sphere 124. Consequently, when the O-ring 147 tries to contract inward, most of this contracting force is converted into a pressing force against the spherical surface 124a. Therefore, in such a configuration, the force with which the O-ring 147 presses the spherical surface 124a (the sealing force) increases significantly, thus increasing the sliding resistance between the O-ring 147 and the spherical surface 124a. As a result, when the rocking body 131 receives an external force and tries to tilt, it is problematically difficult for the tilting movement to occur.

In contrast, in the improved levitation unit 112, as shown in FIG. 9 (b), the O-ring 147 is housed in the ring-shaped groove 145 and a sidewall surface 145a is provided, which contacts the internal side of the O-ring 147. In this configuration, when the O-ring 147 tries to contract inward, the resulting contracting force becomes a pressing force against the spherical surface 124a of the sphere 124 as well as a pressing force against the sidewall 145a. More specifically, the O-ring 147 is pressed against the sidewall surface 145a near the top edge of the sidewall surface 145a, and below this pressing contact area, the pressing force is consumed as a deformation force inside the ring-shaped groove 145. Only above this pressing contact area is the pressing force converted into a force that presses against the spherical surface 124a.

This force distribution results in a relatively smaller pressing force against the spherical surface 124a compared to the configuration not provided with the sidewall surface 145a (see FIG. 9 (a)). Therefore, even when the sliding resistance of the O-ring 147 increases as the O-ring 147 receives the pressure from the air inside the concave housing area 132, this increase is limited, allowing the rocking body 131 to tilt easily.

Next, the operations of a device that corrects the positional shifts in a glass substrate G and which is comprised of multiple levitation units comprised of the aforementioned improved levitation units 112 and ordinary levitation units 11 will be explained. Among these operations, the operation of supporting the glass substrate G on a non-contact basis will be explained in detail using the operation of the improved levitation unit 112 based on FIG. 10.

This positional shift correction device has the same configuration as the positional shift correction device illustrated in FIG. 4, and multiple improved levitation units 112 and ordinary levitation units 11 are provided on the base 2 (see FIG. 4). First, the glass substrate G is placed on the top surfaces of the individual levitation units 1 by a transfer means not shown in the figure.

Here, some degree of waviness has already been generated in the glass substrate G itself by the various types of processing applied to the substrate G, even before it is placed on the levitation device. Consequently, as shown in FIG. 10 (a), before the glass substrate G is placed on the levitation device, the substrate G and the top surface 112a of the improved levitation unit 112 are non-parallel with each other. The glass substrate G is then lowered and placed on the individual levitation units 1 by the transfer means. Then, as shown in FIG. 10 (b), the rocking body 131 and the blocking member 141 tilt tracing the tilt of the glass substrate G. The glass substrate G is supported on a contact basis, with its bottom surface making planar contact with the top surface 112a of the improved levitation unit 112.

Next, air is supplied to each levitation unit 1 via the air channel 103 of the base 2, and then jetted out from the top surface of each levitation unit 1. This jetting air generates a levitational force that levitates the glass substrate G from the top surfaces of the individual levitation units 1 and supports it on a non-contact basis at close intervals. In the improved levitation units 112, as shown in FIG. 10 (c), the glass substrate G levitates, with the top surface 112a and the bottom surface of the glass substrate G (the surface facing the improved levitation unit 112) remaining roughly parallel to each other, and is supported in this state on a non-contact basis. Note that while the actual levitation distance of the glass substrate G from the top surface 112a is only between several and dozens of mm, FIG. 10 (c) shows this levitation distance in an exaggerated manner for ease of explanation. The levitational force generated by the air jetting out of the top surface 112a of the improved levitation unit 112 is reliably applied to the glass substrate G, essentially eliminating the possibility of the glass substrate G contacting the top surface 112a. Since the improved levitation units 112 are provided in locations where the problem of contact would be caused by the waviness in the glass substrate G, if ordinary levitation units 11 were used, that is, at the front, back, left, and right edges shown in FIG. 9, they eliminate the problem of contact.

Afterwards, the multiple correction rollers S provided around the glass substrate G correct any positional shifts. In this embodiment, since the use of the improved levitation units 112 has eliminated the problem of contact between the glass substrate G and the levitation units 1, the glass substrate G is never scratched during this positional shift correction.

As described in detail above, the third embodiment has the following superior effects.

According to the present embodiment, even when waviness is present in the substrate G itself, the rocking body 131 and the porous unit 141 tilt tracing the tilt of the waviness. This tracing movement ensures that the levitational force generated by the jetting air is reliably applied to the glass substrate G. Therefore, if the improved levitation units 12 are provided at the edges of the glass substrate G where the air tends to escape to the outside because of the tilt in the glass substrate G, the substrate G can be reliably supported on a non-contact basis, even at its edges.

Furthermore, the fact that the improved levitation unit 12 can reliably apply the levitational force following the waviness in the glass substrate G as explained above makes reliable non-contact support possible even when the substrate G has waviness. It is also possible to allow significant waviness to occur in the glass substrate G by reducing the number of levitation units 1 installed (reducing the locations where the levitational force occurs). Such a configuration offers the side benefit of reducing cost by reducing the number of levitation units 1 to be installed.

Furthermore, in the present embodiment, the improved levitation unit 112 is configured to prevent the air from escaping to the outside. Therefore, it becomes possible to prevent the air supplied to be jetted from the top surface 112a of the improved levitation unit 112 from being wasted by letting it escape to the outside without being jetted from the top surface 112a. Wasting the air leads to increased operation of the compressor used for generating compressed air, resulting in increased operating cost. However, the present embodiment can reduce the operating cost by reducing the volume of air wasted.

Moreover, in the present embodiment, the O-ring 147 is housed inside the ring-shaped groove 145, rather than on a simple step, and the sidewall surface 145a contacting the internal side of the O-ring 147 is provided. Therefore, even when the pressure of the air inside the concave housing area 132 is applied to the O-ring 147 from its outer side, it is possible to limit increases in the force pressing against the spherical surface 124a of the sphere 124 (the sealing force), as well as increases in the sliding resistance. As a result, the rocking body 131 is allowed to tilt easily.

### Fourth Embodiment

A fourth embodiment will be explained below, referencing drawings. The improved levitation unit 112 in this fourth embodiment has a different configuration from the one in the third embodiment. However, the same name “improved levitation unit” is used in the explanation. Note that FIG. 11 is a cross-sectional diagram of the levitation unit; FIG. 12 is a partial and magnified cross-sectional diagram of the O-ring; and FIG. 13 is a cross-sectional exploded view of FIG. 11.

As shown in FIGS. 11 and 13, the improved levitation unit 160 is provided with a support body 161 and a rocking body 171 that is rockably supported by the support body 161.

The support body 161 has the same configuration as the support body 121 in the third embodiment. That is, the support body 161 has an axle 162, a securing area 163, and a sphere 164, and is provided with an air passage 165 that acts as a support body channel. The air passage 165 has a top opening and a bottom opening. The center line of the axle 162 is aligned with the vertical center line that passes through the center of the securing area 163, as well as the centers of the sphere 164 and the air passage 165 that comprise the support area, and is treated as the center line of the entire improved levitation unit 160. The various components and parts comprising the improved levitation unit 160, described below, are installed using this center line as the reference.

The rocking body 171 has a cylindrical outer shape, and is comprised of an upper member 172 and a lower member 173. Both members have the same cross sectional area. An upper concave area 174 that is capable of housing the upper part of the sphere 164 is formed in the center of the bottom surface of the upper member 172. The sidewall comprising the upper concave area 174 is formed over its entire circumference as an upper tapered surface 175 that acts as a securing area, and the upper concave area 174 is formed in the shape of a downward-facing mortar.

A lower concave area 176 capable of housing the lower part of the sphere 164 is formed in the center of the top surface of the lower member 173. A step 177 is provided around the edge of the upper opening of the lower concave area 176. Part of the sidewall that is located below the step 177 and which forms the lower concave area 176 is formed over its entire circumference as a lower tapered surface 178 that acts as a contact plane or contact area, and the lower concave area 176 is formed in the shape of an upward-facing mortar. The lower tapered surface 178 has a shape that is symmetric with the upper tapered surface 175, and the shapes of the two surfaces are mirror images of each other vertically across the step 177. Furthermore, the bottom of the lower concave area 176 goes through the bottom surface of the lower member 173, and the opening of a throughhole 179 is formed in the center of the bottom surface of the lower member 173. The throughhole 179 is formed such that the axle 162 of the support body 161 and the securing area 163 can fit through.

When the bottom surface of the upper member 172 is aligned with the top surface of the lower member 173 and the two members are secured together by means of securing means, such as bolts, not shown in the figure, the upper concave area 174 and the lower concave area 176 form a housing space 180 that acts as a supporting space. The sphere 164 of the support body 161 is housed in this housing space 180, and in this housed state, the axle 162 and the securing area 163 protrude from the bottom surface of the lower member 173 via the throughhole 179. Furthermore, the spherical surface 164a contacts the upper tapered surface 175 in the upper part of the sphere 164, and the lower tapered surface 178 in the lower part of the sphere 164. As described above, since the upper tapered surface 175 and the lower tapered surface 178 have shapes that are mirror images of each other vertically, the positions at which the sphere 164 contacts the surfaces are also mirror images of each other vertically. Then, based on the contact between the upper tapered surface 175 and the spherical surface 164a of the sphere 164, the rocking body 171, which is formed by joining together the upper member 172 and the lower member 173, is rockably supported by the support body 161. Additionally, this supported state is stably maintained by the contact between the lower tapered surface 178 and the spherical surface 164a.

Furthermore, the rocking body 171 is provided with a porous body 181, which is configured such that air is jetted out from its top surface 181a. The configuration will be described in detail below. Note that the configuration of the porous body 181 itself is the same as that of the porous body 137 described in the first embodiment.

A housing groove 182 is formed in the center of the flat top surface 172a of the upper member 172, which comprises the rocking body 171. The porous body 181 is housed inside the housing groove 182, protruding beyond the top surface 172a. A flow groove 183 is formed on the bottom surface of the housing groove 182. An air passage 184 that acts as a rocking body channel is formed inside the upper member 172. One end of this air passage 184 opens at the bottom surface of the flow groove 183, and the part matching the bottom of the upper concave area 174 is the other opening. Thus, the flow groove 183 is connected to the air passage 184 of the rocking body 171 (more specifically, the air passage 184 of the upper member 172) and to the air passage 165 of the support body 161. When air is supplied via these air passages 165 and 184 to the flow groove 183, this air passes through the micropores in the porous body 181 and jets out from the top surface 181a.

As shown in FIG. 12, when the upper member 172 and the lower member 173 are joined together, an O-ring 186 that acts as a sealing means is installed in a ring-shaped groove 185 that is formed by the bottom surface of the area surrounding the opening of the upper concave area 174 and the step 177 in the lower concave area 176. The O-ring 186 is installed such that it contacts the spherical surface 164a of the sphere 164, the bottom surface of the opening of the upper concave area 174, and the wall of the step 177. With the vertically symmetric tapered surfaces 175 and 178 provided above and below the step 177, the ring-shaped groove 185 is positioned in the center in the vertical direction of the wall forming the housing space 180. Therefore, the O-ring 186 is in contact with the spherical surface 164a over its entire circumference in its equatorial area, which is defined using the center line of the spherical surface 164a as the reference. This single O-ring 186 seals the space among the three members, i.e., the sphere 164, the upper member 172, and the lower member 173, thus preventing the air flowing through the rocking body 171 from leaking to the outside.

Next, the operation of the improved levitation unit 160 having the aforementioned configuration will be explained.

The support body 161 is secured to the base 2 in the same way as in the third embodiment, and air is supplied to the air passage 165. This supplied air jets out from the top surface 181a of the porous body 181, that is, the top surface 160a of the improved levitation unit 160. The jetting air generates a levitational force that levitates the glass substrate G placed on the top surface 160a of the improved levitation unit 160. In the present embodiment, the top surface 160a of the improved levitation unit 160 (the top surface 181a of the porous body 181) is the jetting surface.

Note that although part of the air flowing out of the upper opening of the air passage 165 passes by the contact area between the spherical surface 164a of the sphere 164 and the upper tapered surface 175, reaching the space below, the O-ring 186 prevents this air from leaking to the outside.

When an external force is applied to the rocking body 171, the rocking body 171 follows this force and tilts from the support body 161 while sliding at the contact areas between the sphere 164 and the upper and lower tapered surfaces 175 and 178. In this case, the fact that the contacts between the sphere 164 and the tapered surfaces 175 and 178 are linear contacts in the circumferential direction in which the tapered surfaces 175 and 178 are formed reduces the sliding resistance occurring between these members. The rocking body 171 tilts while also sliding at the contact area between the O-ring 186 and the spherical surface 164a of the sphere 164, and the sealing function between the O-ring 186 and the spherical surface 164a of the sphere 164 is maintained even while the rocking body 161 is tilting as well as after it has tilted.

Furthermore, since the O-ring 186 is configured to contact the sphere 164 in its equatorial area, the pressure of the air passing through the contact area between the spherical surface 164a of the sphere 164 and the upper tapered surface 175 is applied to the internal side of the O-ring 186 as shown in FIG. 12.

The O-ring 186 in response tries to expand outward. The positional configuration of the O-ring 186 makes it difficult for the pressing force, that is, the force with which the O-ring 186 tries to contract inward, to increase. As a result, even when the sliding resistance that occurs between the O-ring 186 and the sphere 164 increases as the O-ring 186 receives the air pressure, this increase is limited, allowing the rocking body 171 to tilt easily.

Using the improved levitation unit 160 in the aforementioned fourth embodiment in a device that corrects the positional shifts in a glass substrate G eliminates the problem of contact when the glass substrate G is levitated.

Therefore, the fourth embodiment has the following superior effects.

In the present embodiment, even when waviness is present in the substrate G itself, the rocking body 171 tilts tracing the tilt of the waviness. This tracing movement ensures that the levitational force generated by the jetting air is reliably applied to the glass substrate G. This results in the same effects as those obtained by the third embodiment.

Additionally, in the present embodiment, the improved levitation unit 160 is configured to prevent the air from leaking to the outside. Therefore, it becomes possible to prevent the air supplied to be jetted from the top surface 160a of the improved levitation unit 160 from being wasted by letting it escape to the outside without being jetted from the top surface 160a.

In the present embodiment, the O-ring 186, which prevents the air from leaking out of the rocking body 171, is installed in a position in contact with the spherical surface 164a in the equatorial area of the sphere 164. Therefore, the pressure of the air is applied to the O-ring 186 from the inside of the ring. The O-ring 186 in response tries to expand outward, limiting increases in the force pressing against the spherical surface 164a of the sphere 164. As a result, even when the O-ring 186 receives the air pressure, the sliding resistance that occurs between the O-ring 186 and the spherical surface 164a of the sphere 164 is prevented from increasing.

In the present embodiment, the O-ring 186 is installed in the ring-shaped groove 185, which is formed by the upper member 172 and the lower member 173, and furthermore, the O-ring 186 installed in the ring-shaped groove 185 is configured to also contact the spherical surface 164a of the sphere 164. Therefore, the single O-ring 186 can be used as a seal between all three members, i.e., the upper member 172, the lower member 173, and the sphere 164. The fact that multiple O-rings need not be installed reduces the manufacturing cost.

### Fifth Embodiment

A fifth embodiment will be explained below, referencing FIG. 14. For the improved levitation unit 190 in the fifth embodiment, only those areas that are different from the improved levitation unit 160 explained in the fourth embodiment will be explained. Like symbols are used for like areas, hence their explanation will be omitted.

The improved levitation unit 190 is different from the aforementioned improved levitation unit 160 in the following ways. That is, in the aforementioned improved levitation unit 160, the step 177 is formed in the lower member 173 and the ring-shaped groove 185 is formed at the top end of the lower member 173. In contrast, in the improved levitation unit 190 of the present embodiment, the aforementioned ring-shaped groove 185 is formed on the bottom end of the upper member 172. As a result, the Q-ring 186 housed there is positioned higher than the center of the spherical surface 164a of the sphere 164. Moreover, the tightening force of the O-ring 186 becomes not only a sealing force that seals the space between the O-ring 186 and the spherical surface 164a, but also a force that pushes the rocking body 171 upward relative to the sphere 164. As a result, in the improved levitation unit 190 of the present embodiment, the spherical surface 164a of the sphere 164 contacts the lower tapered surface 178 as well as the O-ring 186, but is not in contact with the upper tapered surface 175, leaving a gap.

Therefore, the fifth embodiment has the following superior effects.

In the present embodiment, even when waviness is present in the substrate G itself, the rocking body 171 tilts tracing the tilt of the waviness. This tracing movement ensures that the levitational force generated by the jetting air is reliably applied to the glass substrate G. This results in the same effects as those obtained by the third and fourth embodiments.

Additionally, in the present embodiment, the improved levitation unit 190 is configured to prevent the air from leaking to the outside. Therefore, it becomes possible to prevent the air supplied to be jetted from the top surface 160a of the improved levitation unit 190 from being wasted by letting it escape to the outside without being jetted from the top surface 160a.

In the present embodiment, the O-ring 186, which prevents the air from leaking out of the rocking body 171, is installed in a position in contact with the spherical surface 164a from the circumference of the sphere 164. Therefore, the pressure of the air is applied to the O-ring 186 from the inside of the ring. The O-ring 186 in response tries to expand outward, limiting increases in the force pressing on the spherical surface 164a of the sphere 164. Furthermore, the O-ring 186 is installed in a position that contacts the spherical surface 164a above the equatorial area of the sphere 164. When the pressure of the air supplied to the porous body 181 increases, a force occurs that lifts the rocking body 171 from the support body 161. However, the fact that this force does not apply in the direction that compresses the O-ring prevents the pressing force pressing the spherical surface 164a of the sphere 164 from increasing. As explained above, in addition to the same characteristic obtained in the third and fourth embodiments, in which the air pressure is applied to the internal perimeter of the O-ring 186, the positional characteristic in which the O-ring 186 is positioned higher than the center of the spherical surface 164a prevents the sliding resistance generated between the O-ring 186 and the spherical surface 164a of the sphere 164 from increasing further, even when the air pressure is received.

In the present embodiment, the O-ring 186 is installed in the ring-shaped groove 185, which is formed by the upper member 172 and the lower member 173, and furthermore, the O-ring 186 installed in the ring-shaped groove 185 is configured to also contact the spherical surface 164a of the sphere 164. Therefore, the single O-ring 186 can be used as a seal between all three members, i.e., the upper member 172, the lower member 173, and the sphere 164. The fact that multiple O-rings need not be installed reduces the manufacturing cost.

In the present embodiment, only the O-ring 186 is used to seal the space between the support body 161 and the rocking body 171, and the metal seal shown in the fourth embodiment in which the upper tapered surface 175 contacts the spherical surface 164a is not used. Instead, a gap is intentionally formed between the upper tapered surface 175 and the spherical surface 164a Consequently, air can flow smoothly between the upper tapered surface 175 and the spherical surface 164a, reducing the concern that air vibration may occur when air is flowing between the upper tapered surface 175 and the spherical surface 164a.

### Sixth Embodiment

Next, a sixth embodiment will be explained below, referencing FIGS. 15 and 16. Note that FIG. 15 is a cross-sectional diagram of a levitation unit, and FIG. 16 is a cross-sectional exploded view of the levitation unit.

As shown in FIGS. 15 and 16, an improved levitation unit 200 is provided with a support body 211 and a rocking body 221 that acts as a rocking member rockably supported by the support body 211.

The support body 211 is provided with a platform 212. An upper axle 213 that extends upward is formed on the top end of the platform 212, and a lower axle 214 that extends downward is formed on the bottom end. An installation axle 215 that extends upward from the top end surface of the upper axle 213 is provided on the upper axle 213. The upper axle 213, the lower axle 214, and the installation axle 215 are all formed to have circular horizontal cross sections, and the cross sectional area of the installation axle 215 is formed to be somewhat smaller than that of the upper axle 213. Therefore, the top end surface of the upper axle 213, excluding the installation axle 215, forms a sphere support surface 213a. The upper axle 213, the installation axle 215, and the lower axle 214 have a common central axis, which is also the central axis of the support body 211. Along this central axis, an air passage 216 that acts as a support body channel and which opens at the top end surface of the installation axle 215 and the bottom end surface of the lower axle (hereafter respectively referred to as “the upper opening” and “lower opening”) is linearly provided in the support body 211. The central axis of the support body 211 is also the center line of the improved levitation unit 200, and the various components and parts, described below, are installed using this center line as the reference.

As shown in FIG. 16, a pair of flat washers 236 and 237, as well as a wave washer 238, are installed over the upper axle 213 and the installation axle 215. The internal circumferential edges of the flat washers 236 and 237 are beveled. The washers 236, 237, and 238 are installed over the axles 213 and 215, beginning with the second washer 237 on the platform 212 side; followed by the wave washer 238, which acts as a pressing means and an energizing means; and then by the first washer 236. The wave washer 238 is positioned between the pair of flat washers 236 and 237.

Additionally, a sphere 217 is provided on the installation axle 215. A throughhole 218, having roughly the same shape as the horizontal cross section of the installation axle 215, is formed in the sphere 217. A pair of end surfaces that are orthogonal to the center line of the throughhole 218 are formed on the sphere 217, with the throughhole 218 opening at both of these end surfaces. One of the end surfaces, excluding the opening of the throughhole 218, acts as a sphere-supported surface 217b that is formed into a ring shape having the same shape and same area as the sphere support surface 213a of the upper axle 213. Note that for ease of explanation, the other end surface is referred to as a top end surface 217c. Then, with the sphere-supported surface 217b oriented downward, the installation axle 215 is press-fitted into the throughhole 218 of the sphere 217 until the sphere-supported surface 217b contacts the sphere support surface 213a, as a result installing the sphere 217 on the installation axle 215. Since the distance between the sphere-supported surface 217b and the top end surface 217c of the sphere 217 is formed to be longer than the installation axle 215, the top end of the installation axle 215 is positioned lower than the top end surface 217c of the sphere 217 when the sphere 217 is installed.

A securing area 219, such as a screw groove, is formed on the bottom end of the lower axle 214. This support body 211 is installed in the installation target such as the base 2 by means of this securing area 219.

Next, as shown in FIG. 15, the rocking body 221 is formed to have an approximately T-shaped cross section. A concave housing area 222 that can house the sphere 217 is formed in the center of the bottom surface of the rocking body 221. This concave housing area 222 forms a supporting space. The concave housing area 222 is comprised of a first concave area 223 formed on the bottom surface of the rocking body 221 and a second concave area 225 formed on the bottom surface 223a of the first concave area 223.

The first concave area 223 is formed to have the same circular shape having approximately the same diameter as the outer diameter of the pair of flat washers 236 and 237 provided on the support body 211 on the horizontal cross section of the rocking body 221. A ring-shaped installation groove 224 is formed on the internal circumferential surface 223b, which forms the first concave area 223. Meanwhile, the second concave area 225 is also formed to have a circular shape on the horizontal cross section of the rocking body 221. An O-ring 226, which acts as a sealing means, is provided on the bottom surface 225a of the second concave area 225. This O-ring 226 has approximately the same outer diameter as the diameter of the second concave area 225, and is installed to be in contact with the bottom surface 225a of the second concave area 225 and the internal circumferential surface 225b, which forms the concave area 225. Note that the second concave area 225, together with the first concave area 223, forms the supporting space and also functions as a seal-mounting groove.

The sphere 217 of the support body 211 is housed inside the second concave area 225. In this housed state, the upper portion of the spherical surface 217a of the sphere 217 contacts the O-ring 226. Furthermore, with the O-ring 226 contacting the sphere 217, the top end surface of the sphere 217 is separated from the bottom surface of the second concave area 225 in the downward direction. This contact between the O-ring 226 and the sphere 217 rockably supports the rocking body 221 on the support body 211.

Furthermore, with the sphere 217 housed inside the second concave area 225, the individual washers installed in the support body 211 are pushed toward the sphere 217, with the internal circumferential edge of the first washer 236 making contact with the spherical surface 217a of the sphere 217. In this state, a snap ring 227 is provided in the installation groove 224 formed on the internal circumferential surface 223b of the first concave area 223. As a result, the snap ring 227 contacts the second washer 237, restricting the movement of the individual washers 236, 237 and 238 toward the platform 212 and keeping the first washer 236, at its internal circumferential edge, in contact with the spherical surface 217a of the sphere 217. Furthermore, the first washer 236 is urged upward by the wave washer 238, which is present between the pair of flat washers 236 and 237, increasing the force of the contact with the spherical surface 217a of the sphere 217. Additionally, the snap ring 227 is urged downward via the second washer 237 and pressed against the wall of the installation groove 224. This prevents any rattling from occurring between the snap ring 227 and the installation groove 224.

On the bottom surface of the second concave area 225, an introduction groove 228 that has a larger opening diameter than the top end surface 217c of the sphere 217 is formed in the area that is inside the O-ring 226 and which faces the top end surface 217c. Additionally, the top surface 221a of the rocking body 221 is formed to be flat, and a housing groove 229 is formed on the top surface 221a. A porous body 230 is housed inside the housing groove 229, protruding beyond the top surface 221a. The porous body 230 is formed from a fluorine resin, such as a sintered trifluoride resin or a sintered tetrafluoride resin. A flow grove 231 is formed on the bottom surface of the housing groove 239. An air passage 232 that opens at the bottom surface of this flow grove 23i and at the bottom surface of the introduction groove 228, and which connects the two grooves 228 and 231, is formed linearly in the rocking body 221. By means of this air passage 232, the flow grove 231 is also connected to the air passage 216 of the support body 211 via the space in the second concave area 225 sealed by the O-ring 226. When air is supplied via these air passages 216 and 232 to the flow grove 231, this air passes through the micropores in the porous body 230 and jets out from the top surface 230a. In the present embodiment, the top surface 230a of the porous body 230 is the jetting surface. Note that in addition to a fluorine resin, the porous body 230 can also be formed from a synthetic resin material such as a sintered nylon resin or a sintered polyacetal resin; a metal material such as sintered aluminum, sintered copper, and sintered stainless steel; a sintered carbon; a sintered ceramic, or the like.

Next, the effects of the improved levitation unit 200 thus configured will be explained.

This support body 211 is installed in the installation target by means of the securing area 219 provided on the lower axle 214, and air is supplied to the air passage 216. This supplied air is jetted out of the top surface 230a of the porous body 230, that is, the top surface 200a of the improved levitation unit 200. This jetting air generates a levitational force that levitates the glass substrate G placed on the top surface 200a of the improved levitation unit 200.

Then, part of the air flowing out of the upper opening of the air passage 216 of the support body 211 passes through the second concave area 225 to reach the introduction groove 228, but is prevented from leaking to the outside by the O-ring 226. Additionally, the airflow increases the pressure on the inside of the O-ring 226, and this internal pressure is applied to the O-ring 226 from the inside. As a result, the O-ring 226 tries to expand, thus increasing the force pressing on the spherical surface 217a of the sphere 217, as well as on the bottom surface 225a and internal circumferential surface 225b of the second concave area 225. Since this increase in the internal pressure produces a reliable sealing force, a deformation allowance of 10% or less is sufficient for the O-ring 226.

When an external force is applied to the rocking body 221, the rocking body 221 follows this force and tilt from the support body 211 while sliding at the contact area between the spherical surface 217a of the sphere 217 and the O-ring 226. In this case, the fact that the contact between the spherical surface 217a and the O-ring 226 is a linear contact in the circumferential direction reduces the sliding resistance between these two members. The rocking body 221 tilts while also sliding at the contact area between the spherical surface 217a of the sphere 217 and the internal circumferential edge of the first washer 236, and the contact state between these two members is maintained by the urging force of the wave washer 238 even while the rocking body 221 is tilting as well as after it has tilted. Furthermore, the sealing function between the O-ring 226 and the spherical surface 217a of the sphere 217 is also maintained while the rocking body 221 is tilting and after it has tilted.

Therefore, using the improved levitation unit 200 in the aforementioned sixth embodiment in a device that corrects the positional shifts in a glass substrate G eliminates the problem of contact when the glass substrate G is levitated.

Therefore, the sixth embodiment has the following superior effects.

In the present embodiment, even when waviness is present in the substrate G itself, the rocking body 221 tilts tracing the tilt of the waviness. This tracing movement ensures that the levitational force generated by the jetting air is reliably applied to the glass substrate G. This results in the same effects as those obtained by the third through fifth embodiments.

Additionally, in the present embodiment, the improved levitation unit 200 is configured such that the contact between the O-ring 226 and the spherical surface 217a of the sphere 217, as well as the contact between the O-ring 226 and the bottom surface 225a and internal circumferential surface 225b of the second concave area 225, prevent the air from leaking to the outside. Therefore, it becomes possible to prevent the air supplied to be jetted from the top surface 200a of the improved levitation unit 200 from being wasted by letting it escape to the outside without being jetted from the top surface 200a.

The present embodiment is configured such that the O-ring 226 provided inside the second concave area 225 contacts the spherical surface 217a of the sphere 217, enabling the support body 211 to rockably support the rocking body 221. This configuration is simple and furthermore, removes the need for high-precision processing. In addition, this configuration is lower in cost than the configuration in which the top and bottom of the sphere 217 are held between tapered surfaces to allow the rocking body 221 to rock freely.

In the present embodiment, the first washer 236, which contacts the spherical surface 217a in the lower part of the sphere 217, is provided on the support body 211. Therefore, the lower part of the sphere 217 contacts the first washer 236, maintaining the sphere 217 in a stable state. Additionally, the urging force of the wave washer 238 increases the force with which the first washer 236 presses on the spherical surface 217a, thus reliably maintaining the contact state between the first washer 236 and the sphere 217.

Furthermore, when the rocking body 221 tilts, the contact state between the two members is reliably maintained even while it is tilting as well as after it has tilted. As a result, the sphere 217 is held even more stably, thereby helping stabilize the support and rocking of the rocking body 221.

In the present embodiment, the downward movement of the washers 236, 237 and 238 is restricted and the contact state between the first washer 236 and the spherical surface 217a of the sphere 217 is maintained by means of the snap ring 227 alone. Thus, the number of parts required is smaller than in a configuration that obtains the same effects by securing a blocking member by means of bolts. This also helps reduce cost. Of course, when only the snap ring 227 is used, rattling occurs between it and the installation groove 224, causing the problem of unstable contact between the first washer 236 and the sphere 217. For this reason, in the present embodiment, the second washer 237 is provided between the snap ring 227 and the first washer 236, with a wave washer 238 inserted between the two washers 236 and 237. The urging force of this wave washer 238 is also applied to the snap ring 227 via the second washer 237, thus preventing rattling from occurring.

In the present embodiment, the O-ring 226 having approximately the same outer diameter as the diameter of the second concave area 225 is installed to be in contact with the bottom surface 225a and internal circumferential surface 225b of the second concave area 225. Therefore, there is no need to form an installation groove for installing the O-ring 226 in the internal circumferential surface 225b, which forms the second concave area 225, along the circumferential direction. Moreover, since the installation of the O-ring 226 is accomplished by simply installing the O-ring 226 on the bottom surface 225a of the second concave area 225, the work required is extremely simple.

### Other Embodiments

Note that the aforementioned first through sixth embodiments are not limited to the configurations described above, and may also be implemented as described below.

In the first embodiment, the air supplied to the first channel 24 flows between the concave sphere 23 and the convex sphere 33, generating an air film. However, another configuration may also be used. For example, a porous body could be provided on the concave sphere 23 and air could be jetted out of this porous body toward the convex sphere 33, or a simple sliding bearing could be used between the two members.

In the first embodiment, air is supplied to the porous body 44 and the spherical bearing by means of a common channel, that is, the first channel 24. However, air could be supplied by means of separate supply channels.

In the first embodiment, when the glass substrate G is being placed on the levitation device, a volume of air sufficient to generate an air film between the two spheres 23 and 33 is supplied to the first channel 24 to reduce the frictional resistance, and afterwards, a volume of air sufficient to generate a levitational force for levitating the glass substrate G is supplied. However, a configuration could be used in which a volume of air sufficient to generate the levitational force is supplied when the glass substrate G is placed on the levitation device. In this case, the operation for generating an air film and the operation for levitating the glass substrate G would be simultaneously completed, thereby improving the temporal efficiency of the positional shift correction task.

In the second embodiment, a simple sliding bearing is used between the two spheres 23 and 23. However, a ball bearing may be used instead.

In the second embodiment, it is possible to use a configuration that does not use the cylindrical cover 34. Such a configuration would simplify the configuration of the levitation unit 50. Note that the elastic tube 55 comprises both the disengagement prevention means and the rocking restriction means in this case.

In the first and second embodiments, the rocking substrate 31 is secured to the porous unit 41 by means of bolts. However, it is also possible to omit the porous unit and install the porous body 44 directly on the rocking substrate 31. In this case, the rocking substrate 31 comprises the rocking body. Since this configuration reduces the number of parts needed, it can help reduce cost.

In the first and second embodiments, the concave sphere 23 is provided on the platform 21 and the convex sphere 33 is provided on the rocking substrate 31. However, these spheres 23 and 33 may be exchanged with each other. That is, it is possible to install a convex sphere on the platform 21 and a concave sphere on the rocking substrate 31.

In the first and second embodiments, the convex sphere 33 is formed on the bottom surface side of the rocking substrate 31 to comprise a spherical bearing. However, the spherical bearing may also be configured as illustrated in FIG. 17. That is, in FIG. 17, the convex sphere 62 of the rocking base 61 is provided on the side of the rocking base 61. This rocking base 61 is provided on its top with a porous unit 63. An air supply hole 65 is formed in a housing 64, and when air is supplied to this air supply hole 65, the air is supplied to the porous body 63a via an air passage 66 inside the rocking base 61. As a result, air jets out of the top surface of the porous body 63a and levitates a glass substrate not shown in the figure. Furthermore, the air supplied to the air supply hole 65 passes through the space between the convex sphere 62 and the concave sphere 67 of the housing 64, forming an air film between them, which permits the tracing movements of the rocking base 61. Note that a simple sliding bearing or a ball bearing configuration may be used between the convex sphere 62 and the concave sphere 67.

In the first and second embodiments, a spherical bearing comprised of the concave sphere 23 and the convex sphere 33 is provided, allowing the porous unit 41 to rock. However, as shown in FIG. 18, a bellows 68 could be provided instead between the porous unit 41 and the base 2 to allow the porous unit 41 to rock. Moreover, the configuration is not limited to the use of the bellows 68, and an elastic body made of rubber or the like could also be used. In this case, these intervening members comprise rocking means.

It is possible to add to the first and second embodiments, a configuration in which the top surface 112a becomes horizontal when no glass substrate G is placed on the levitation device (in the neutral state). For example, as shown in FIGS. 19 and 20, four screw holes 81 that extend toward the center of the unit main body 43 can be formed at equal intervals (at 90-degree intervals) on the side of the unit main body 43. Then, screws 82 having hexagonal holes are screwed into the screw holes 81. In this case, by adjusting how far each screw 82 is screwed in, it is possible to adjust the weight balance of the rocking substrate 31 and the porous unit 41 in the horizontal direction, such that the top surface 112a is horizontal in the neutral state. Note that the distance from the top surface 112a to the bottom edge of the convex sphere 33 is shorter than the radius of curvature of the convex sphere 33. Consequently, when an air film is generated between the two spheres 23 and 33 in the neutral state, the rocking substrate 31 and the porous unit 41 naturally return to positions at which the weight is balanced in the horizontal direction. Therefore, by adjusting the weight balance as explained above, the top surface 112a naturally becomes horizontal after the task of supporting the glass substrate G is finished, making it easy to position a glass substrate G during the next operation.

The third embodiment is configured such that the O-ring 147 seals the space between the spherical surface 124a of the sphere 124 and the top surface 141a of the blocking member 141. However, it is also possible to use a configuration in which a metal seal is provided in place of the O-ring. In this case, the area surrounding the insertion hole 143 of the top surface 141a of the blocking member 141 must be formed to be spherical. In such a configuration, the metal seal area must be processed with high precision, which raises the cost compared to the configuration that uses the O-ring 147. However, since the area requiring high-precision processing is limited to the area surrounding the insertion hole 143, significant cost increase can be limited. Note that regardless of whether an O-ring or metal seal is used, the sealed area should preferably shut off the airflow completely. However, a small amount of air leakage will not cause any problem if the device is used in an environment that tolerates such leakage.

In the forth embodiment, the ring-shaped groove 185 is formed by the step 177 formed on the side of the lower member 173 and the bottom surface of the area around the opening of the upper concave area 174. However, a step can be provided on the upper member 172 as well, and the ring-shaped groove 185 formed using the steps of the two members 172 and 173 (see FIG. 21).

In the third through fifth embodiments, the spheres 124 and 164 are provided on the support body 121 and 161, and the tapered surface 135 and the upper tapered surface 175 which contact the spheres 124 and 164 are provided on the rocking bodies 131 and 171 to rockably support them. However, the support configuration may also be reversed. For example, FIG. 21 shows a support configuration that is reversed from that in the fourth embodiment. This configuration has a support body 191 and a rocking body 192, with a housing space 193 provided inside the support body 191, and a tapered surface 194 that supports the rocking body 192 is formed on the support body 191 side. The rocking body 192 is provided with a sphere 195 that is housed inside the housing space 193 and a porous support 197 that is linked to the sphere 195 via an axle 196. Such a configuration can also rockably support the rocking body 192.

Note that in this case, it is also possible to configure an upper member 198 comprising the support body 191 from two blocks, and to form a mortar-shaped upper concave area 198a by joining the two blocks into a single unit. With such a configuration, it is possible to configure the upper member 198 by assembling the two blocks after assembling the rocking body 192 into the lower member. As a result, the upper member 198 can be easily assembled, even when it is not possible to insert the porous support 197 through an insertion hole 199 that goes through the axle 196.

In the sixth embodiment, the sphere 217 is provided on the support body 211, and the concave housing area 222 and the O-ring 226 are provided on the rocking body 221, thus rockably supporting the rocking body 221. However, this configuration may be reversed. An example is illustrated in FIG. 22 as an improved levitation unit 240. In this configuration, a concave housing area 242 is formed in the support body 241, and an O-ring 243 is installed in this concave housing area 242. An air passage 244 that is connected to the concave housing area 242 is also formed in the support body 241. Meanwhile, a sphere 246 is provided on a rocking body 245. Furthermore, an air passage 248, one end of which is connected to a porous body 247 while the other end is connected to the air passage 244 of the support body 241 via the space sealed by the O-ring 243, is formed in the rocking body 245. Thus, air is supplied to the porous body 247 via the air passages 244 and 248, and as a result, jets out of the top surface 247a of the porous body 247 (the top surface 240a of the improved levitation unit 240). The sphere 246 is housed inside the concave housing area 242 and contacts the O-ring 243, rockably supporting the rocking body 245. Since this support configuration is merely a vertically reversed version of the support configuration in the sixth embodiment, a detailed explanation is omitted. This improved levitation unit 240 also provides the same effects as the sixth embodiment.

In the sixth embodiment, the wave washer 238 is provided between the first washer 236 and the second washer 237 as a pressing and urging means. However, a means other than a wave washer may also be used. For example, an elastic body such as rubber, a coned disc spring, a coil spring, or the like may also be used.

In the sixth embodiment, the O-ring 226 is used as the sealing means. However, another means such as a D-ring may also be used.

In the first through seventh embodiments, the improved levitation unit 12, 50, 112, 160, 190, 200, or 240 is provided only at the front, back, left, and right edges shown in FIG. 4. However, the improved levitation unit 12, 50, 112, 160, 190, 200, or 240 may also be used for all of the levitation units. According to this configuration, even when a glass substrate G that is smaller than expected is placed on the levitation device, reliable non-contact support can be achieved. Furthermore, if the improved levitation unit 12, 50, 112, 160, 190, 200, or 240 is used for all of the levitation units, the glass substrate G can be reliably supported on a non-contact basis in any location where these units 12, 50, 112, 160, 190, 200, or 240 are provided. This allows the number of levitation units 1 to be installed on the base 2 to be reduced. As a result, even though the cost of the improved levitation unit 12, 50, 112, 160, 190, 200, or 240 itself, may be higher than an ordinary levitation unit 11, the total number of devices that must be installed can be reduced, thereby canceling the cost increase and suppressing the overall cost.

Since the four corners are the areas where air can most easily escape, it is possible to use a configuration in which improved levitation units 12, 50, 112, 160, 190, 200, or 240 are provided only at these corners. Even such a configuration can provide more reliable non-contact support than a conventional levitation device.

In the aforementioned embodiments, air is used to levitate the glass substrate G. However, the pressurized gas to be jetted is not limited to air. For example, a gas such as nitrogen may also be used.

In the first through fifth embodiments, explanations are provided for a case in which a glass substrate G is used as the workpiece. However, the workpiece is not restricted to a glass substrate G, and any thin, plate-shaped workpiece may be used.

### BRIEF EXPLANATION OF DRAWINGS

FIG. 1 A cross-sectional diagram (cross-sectional diagram along line A-A in FIG. 2) of a levitation unit with a tilting function according to the first embodiment.

FIG. 2 A perspective diagram of a levitation unit with a tilting function according to the first embodiment.

FIG. 3 A schematic diagram illustrating the process from placing a glass substrate on a device to its levitation.

FIG. 4 A plan view illustrating the state in which the positional shift of a glass substrate has been corrected.

FIG. 5 A cross-sectional diagram of a levitation unit with a tilting function according to the second embodiment.

FIG. 6 A cross-sectional diagram (cross-sectional diagram along line B-B in FIG. 7) of a levitation unit with a tilting function according to the third embodiment.

FIG. 7 A perspective diagram of a levitation unit with a tilting function according to the third embodiment.

FIG. 8 A cross-sectional exploded view of the levitation unit with a tilting function according to the third embodiment.

FIG. 9 A diagram illustrating the operation of an O-ring.

FIG. 10 A schematic diagram illustrating the process from placing a glass substrate on a device to its levitation.

FIG. 11 A cross-sectional diagram of a levitation unit with a tilting function according to the fourth embodiment.

FIG. 12 A partial and magnified cross-sectional diagram of the O-ring.

FIG. 13 A cross-sectional exploded view of the levitation unit with a tilting function according to the fourth embodiment.

FIG. 14 A cross-sectional diagram of a levitation unit with a tilting function according to the fifth embodiment.

FIG. 15 A cross-sectional diagram of a levitation unit with a tilting function according to the sixth embodiment.

FIG. 16 A cross-sectional exploded view of the levitation unit with a tilting function according to the sixth embodiment.

FIG. 17 A cross-sectional diagram illustrating a levitation unit with a tilting function according to another embodiment.

FIG. 18 A cross-sectional diagram illustrating a levitation unit with a tilting function according to still another embodiment.

FIG. 19 A cross-sectional diagram (cross-sectional diagram along line C-C in FIG. 20) of a levitation unit with a tilting function according to another embodiment.

FIG. 20 A perspective diagram of a levitation unit with a tilting function according to another embodiment.

FIG. 21 A cross-sectional diagram illustrating a levitation unit with a tilting function according to yet another embodiment.

FIG. 22 A cross-sectional diagram illustrating a levitation unit with a tilting function according to still another embodiment.

FIG. 23 A schematic diagram illustrating the state in which a glass substrate is levitated using a conventional levitation unit.

FIG. 24 A cross-sectional exploded view of an edge of the glass substrate in FIG. 23.

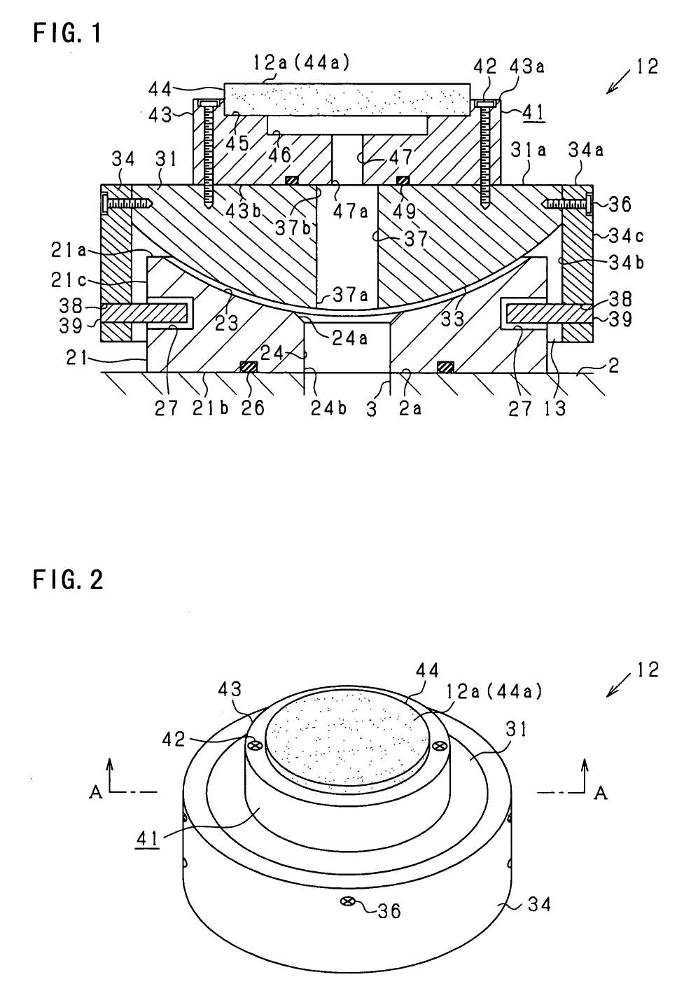

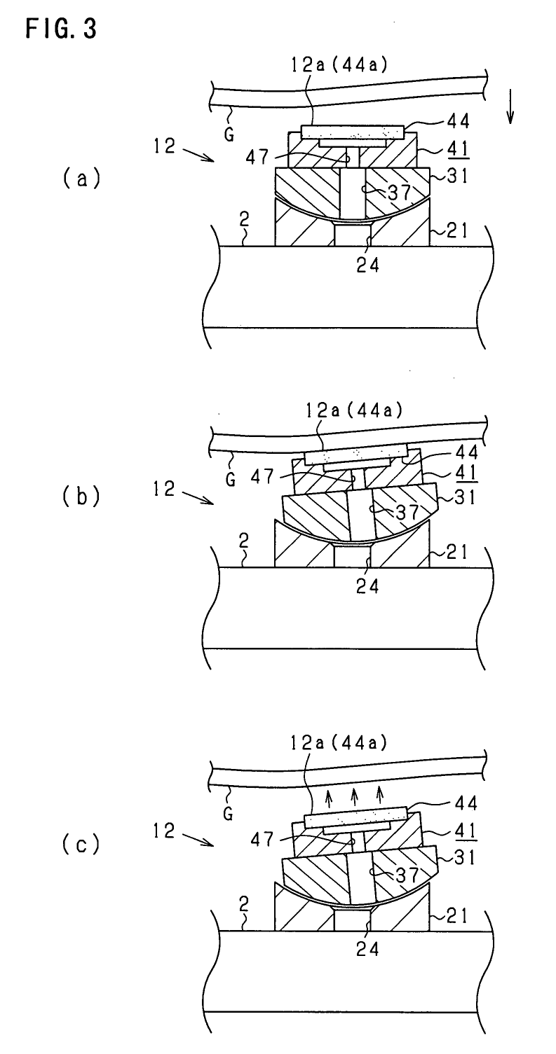

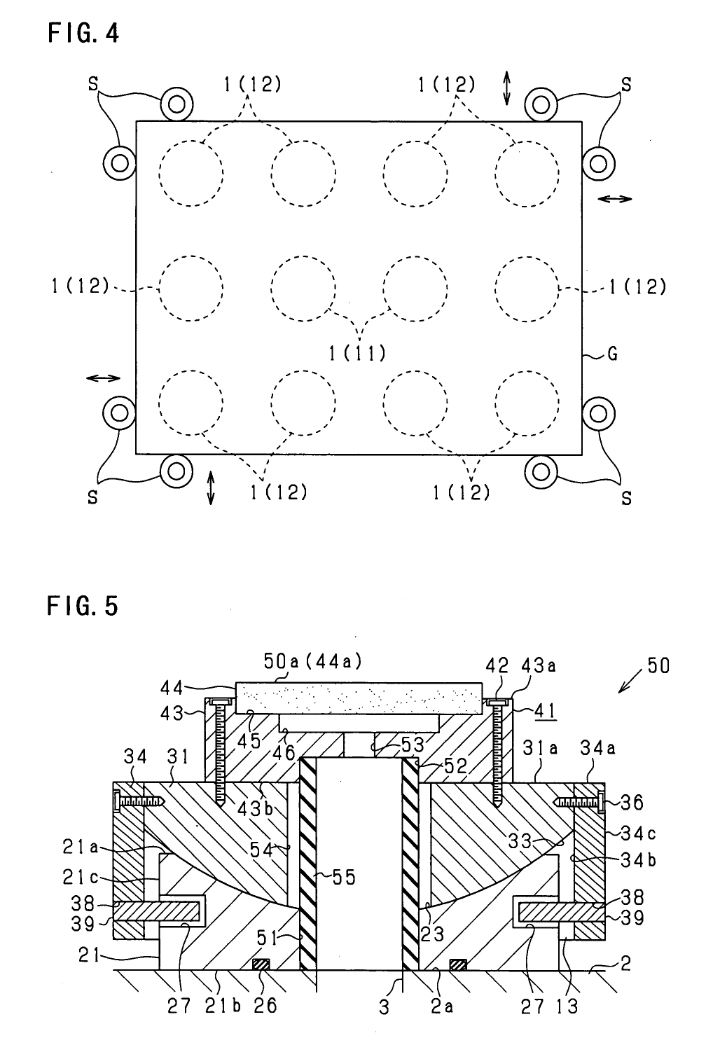

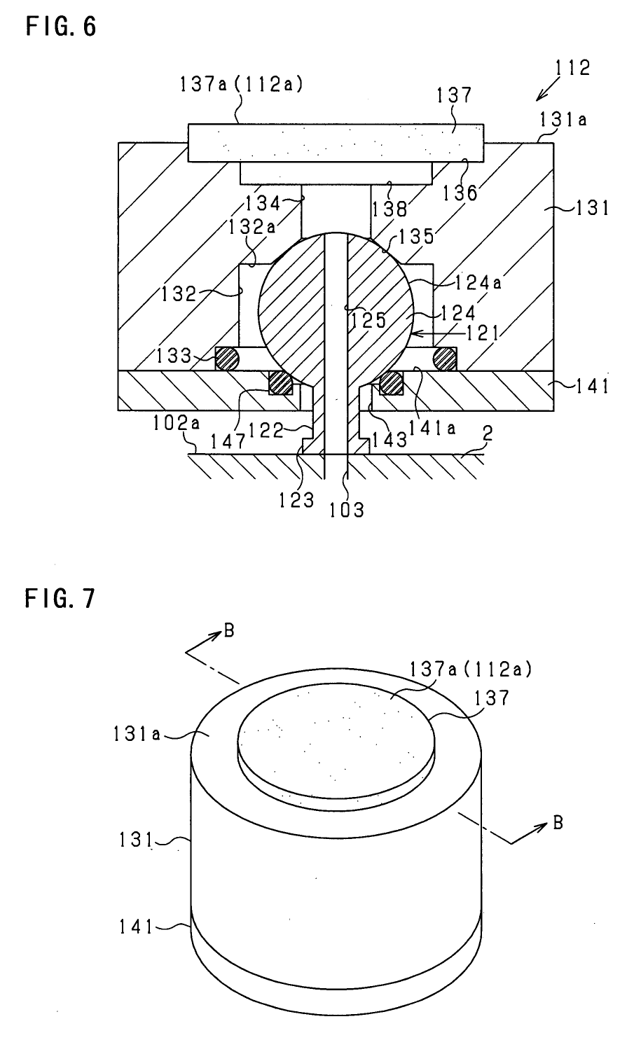

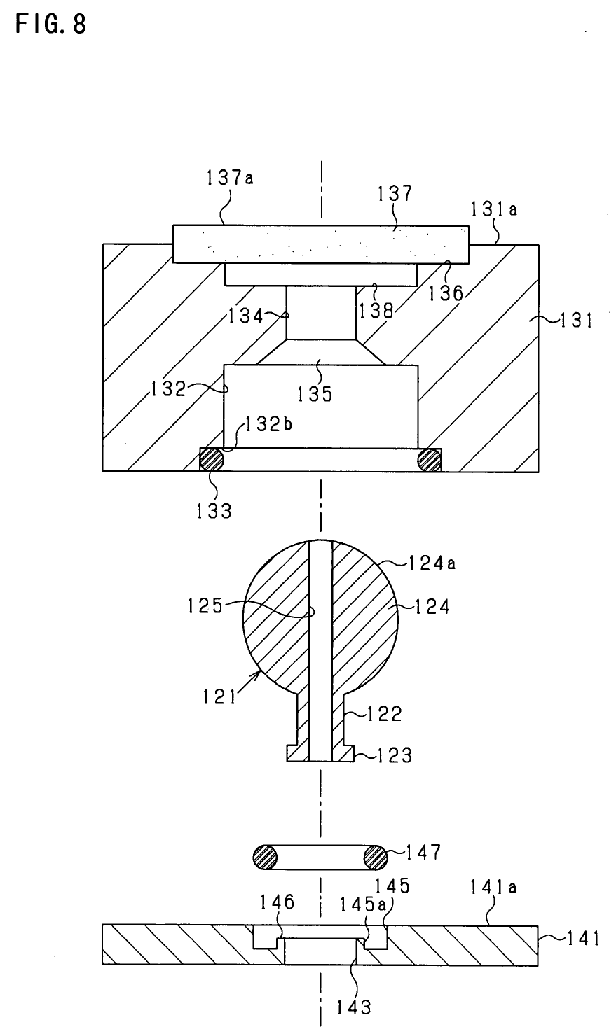

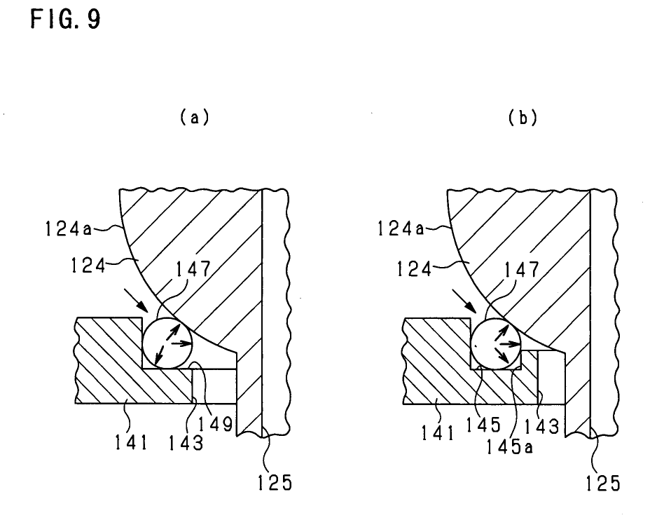

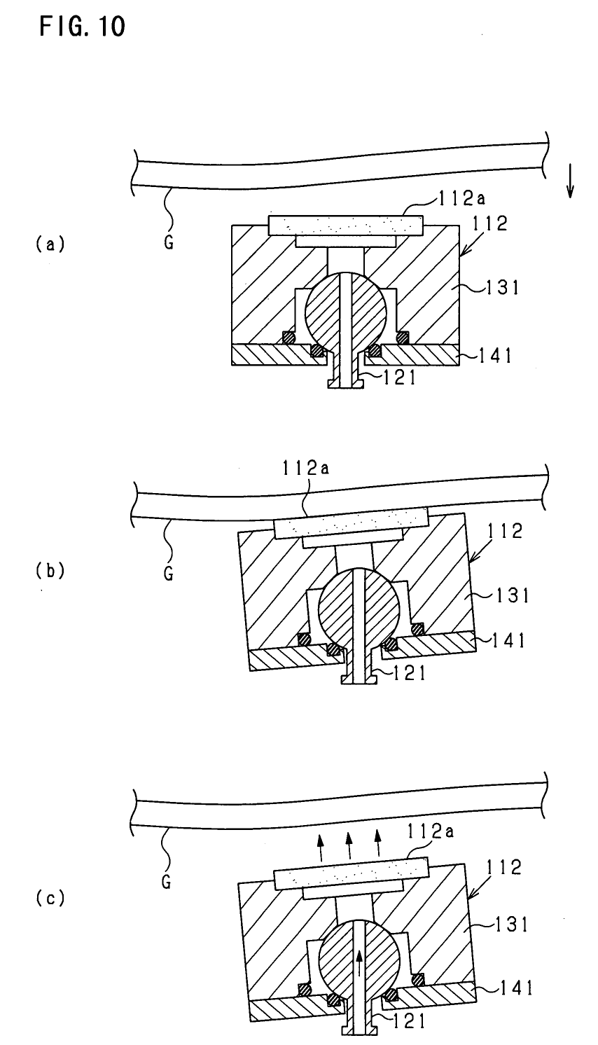

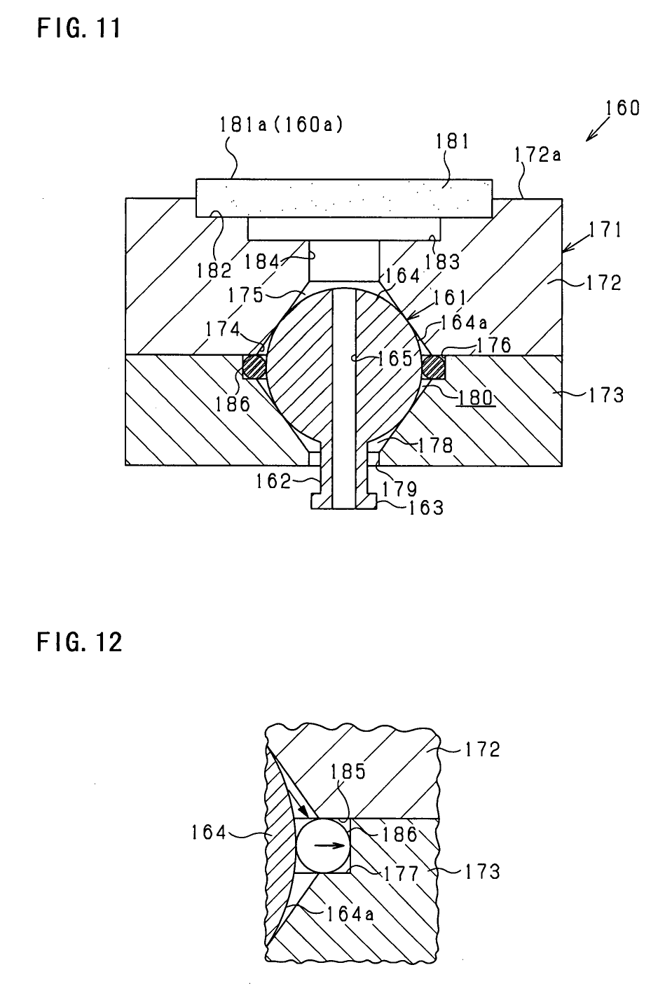

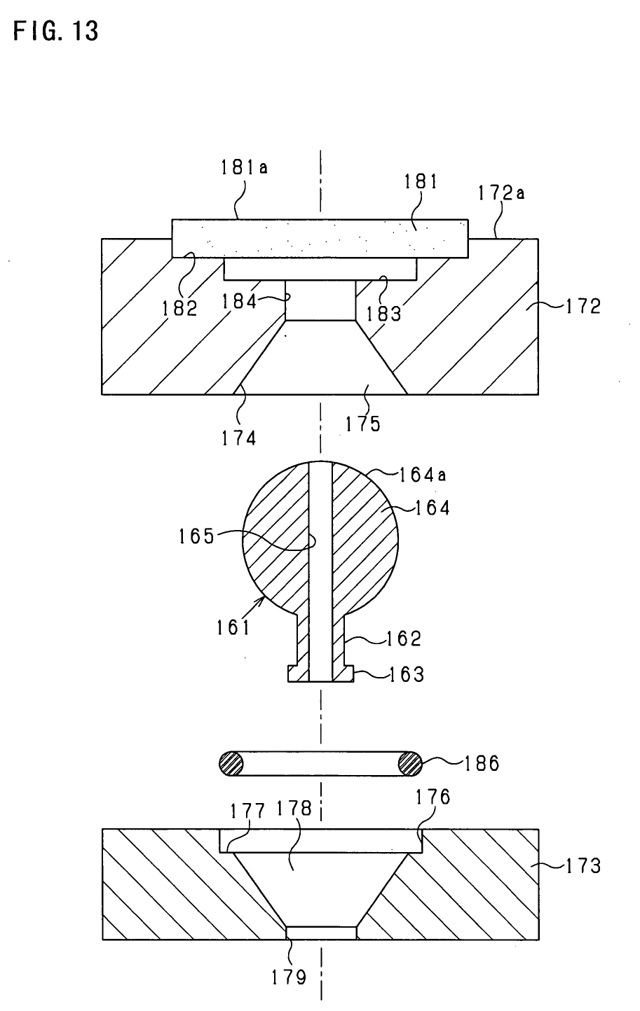

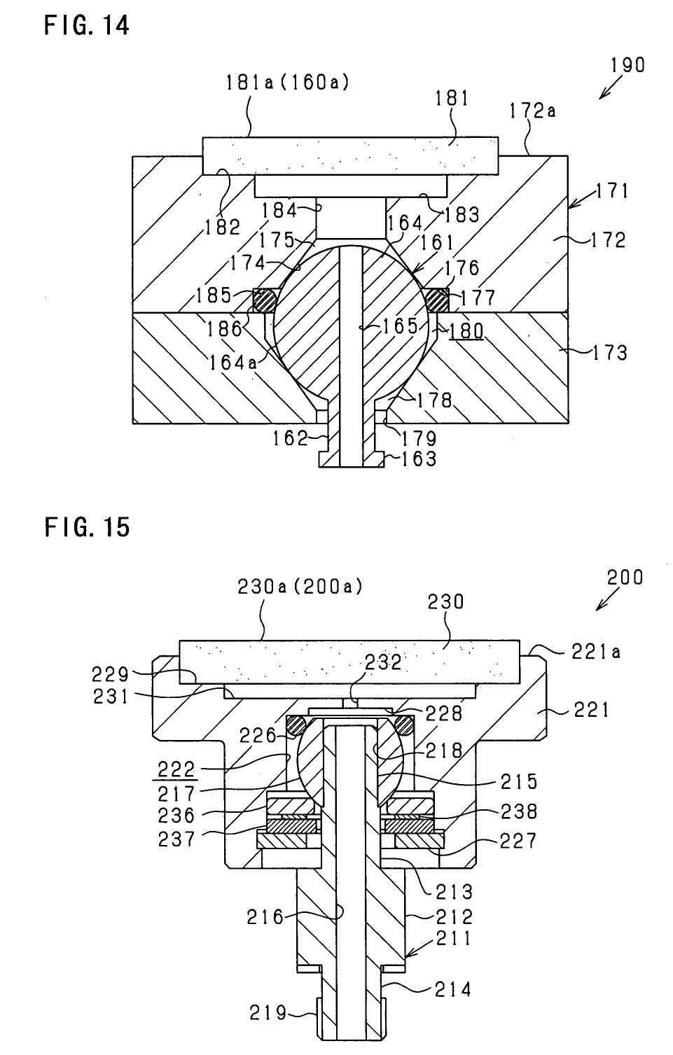

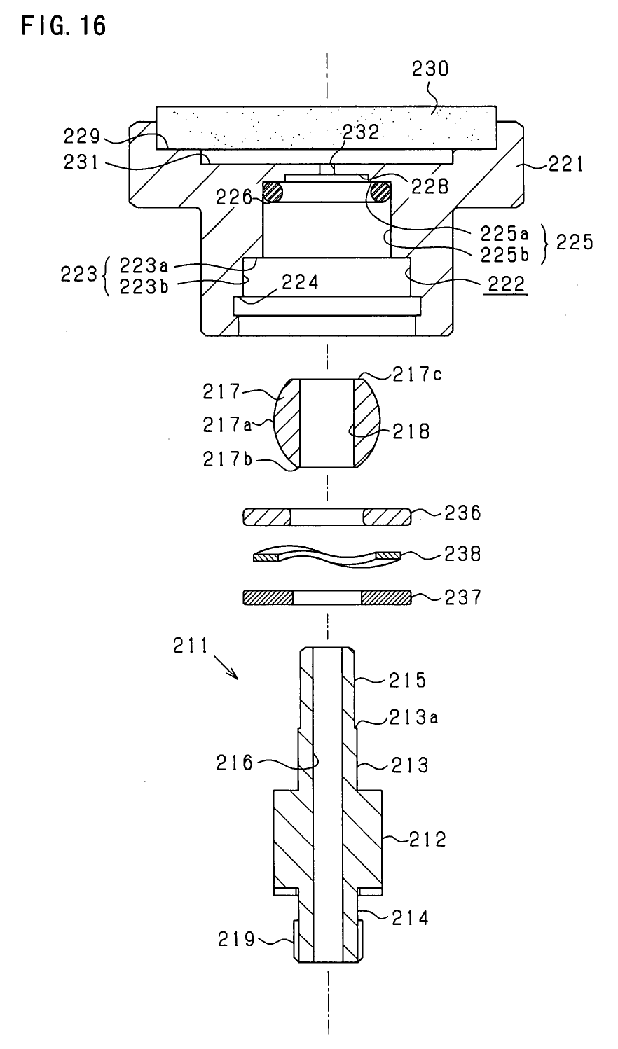

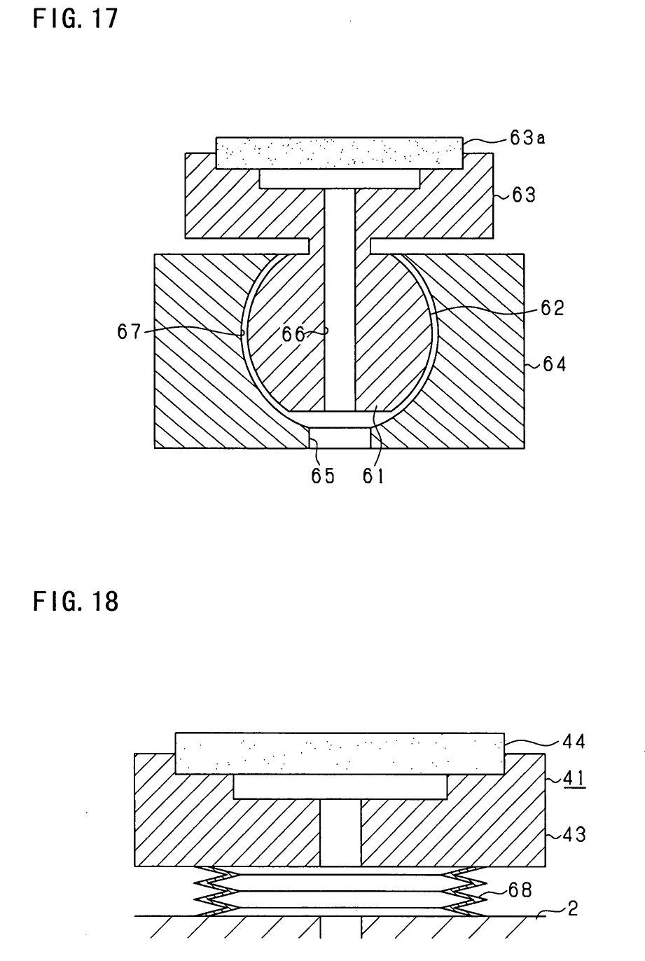

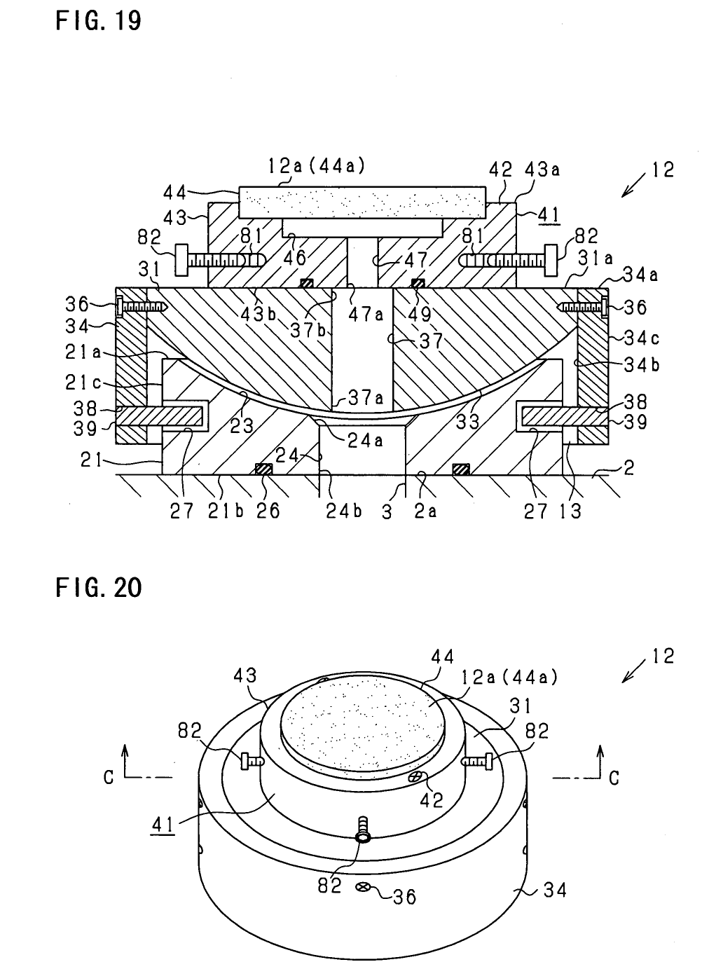

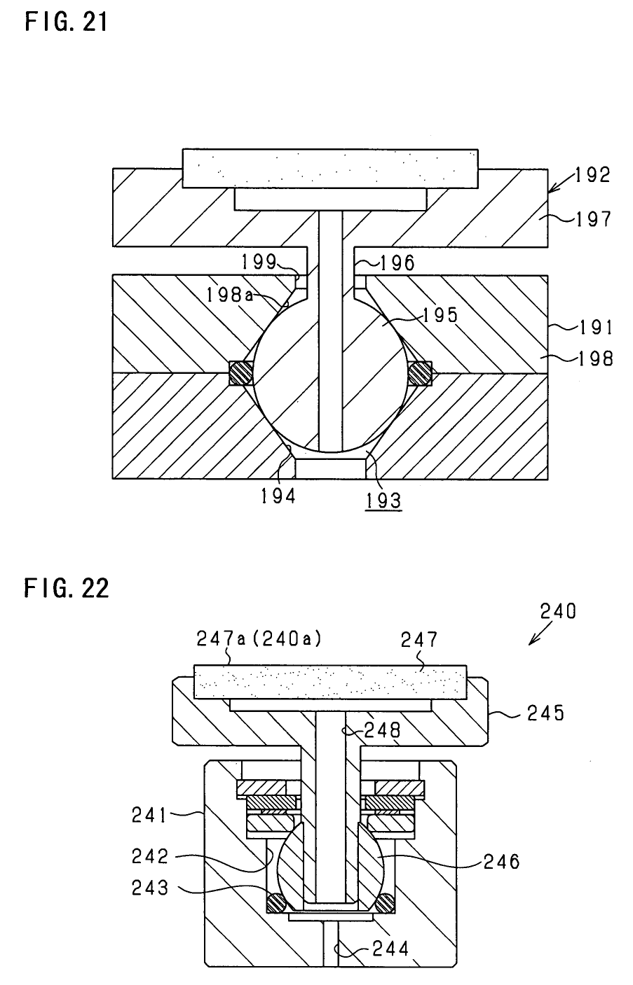

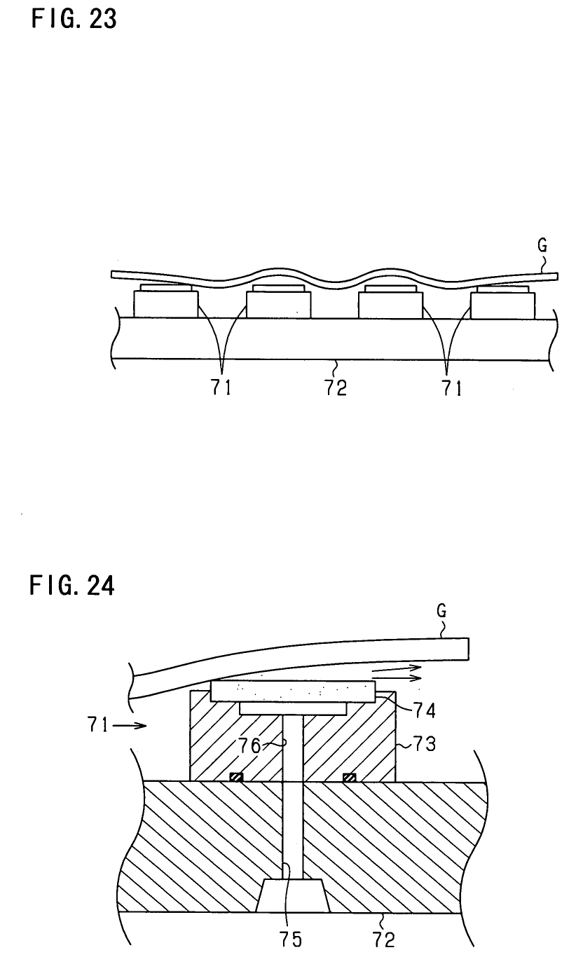

1. A levitation unit with a tilting function that is provided with a jetting surface from which pressurized gas jets out, and with
a rocking means that allows the jetting surface to be passively tilted; and
that supports a workpiece free of contact with the jetting surface by means of the pressurized gas jetting out from the jetting surface.

2. The levitation unit with a tilting function according to claim 1, further provided with a balance adjustment means that adjusts the weight balance of the rocking member in the horizontal direction.

3. The levitation unit with a tilting function according to any of claims 1, wherein the jetting surface is formed from a porous body.

4. A levitation unit with a tilting function that supports a workpiece free of contact with a jetting surface by means of the pressurized gas jetting out from the jetting surface, provided with
a rocking member provided with the jetting surface and in which either a convex spherical surface or a concave spherical surface, both of the spherical surfaces have the same radius of curvature, is formed on the side opposite the jetting surface, and with
a platform that forms the corresponding convex or concave spherical surface, and which supports the rocking member with the two spherical surfaces fitted together; wherein
the presence of a pressurized gas between the platform and the rocking member allows the rocking member to rock along the spherical surface, permitting the jetting surface to be passively tilted.

5. The levitation unit with a tilting function according to claim 4, further provided with a balance adjustment means that adjusts the weight balance of the rocking member in the horizontal direction.

6. The levitation unit with a tilting function according to any of claims 4, wherein the jetting surface is formed from a porous body.

7. A levitation unit with a tilting function that is provided with a jetting surface from which a pressurized gas is jetted, and that supports a workpiece free of contact with the jetting surface by means of the pressurized gas jetting out from the jetting surface, and
that is provided with a rocking member having the jetting surface as well as a support member that is secured to an installation surface and supports the rocking member; wherein
the supported part of the rocking member and the supporting part of the supporting member are disposed inside a supporting space provided in either the rocking member or the supporting member, with the supported part and the supporting part configured such that the rocking member can freely rock, using as a reference the state in which the jetting surface is parallel to the installation surface of the support member; and wherein
the support member is provided with a support member channel, the rocking member is provided with a rocking member channel connected to the jetting surface, the support member channel is connected to the rocking member channel inside the supporting space, and a sealing means is provided to prevent the pressurized gas from leaking from the supporting space.

8. The levitation unit with a tilting function according to claim 7, wherein the rocking member and the supporting member are disposed with their centers aligned along a single line in the vertical direction, and the supporting space is formed with the center line at its center.

9. The levitation unit with a tilting function according to any of claims 7, wherein the jetting surface is formed from a porous body.

10. A levitation unit with a tilting function that is provided with a jetting surface from which a pressurized gas is jetted, and that supports a workpiece free of contact with the jetting surface by means of the pressurized gas jetting out from the jetting surface, and
with a supporting member that has a spherical member, on the bottom end of which an axle extending in the vertical direction is provided, the axle being provided with a securing part that is secured to an installation surface, and that also has a supporting member channel that opens at the spherical surface of the spherical member; and is also provided with
a rocking member provided with a jetting part having the jetting surface on its top surface, containing a supporting space for housing the spherical member, with the opening of an insertion hole connecting the interior of the supporting space to the outside provided face down with the axle being inserted into the insertion hole, and a downward-facing, mortar-shaped tapered surface provided in the top part of the supporting space with the tapered surface contacting the spherical surface of the spherical member; and further provided with a rocking member channel that is connected to the jetting part and opens at the surface that forms the supporting space; wherein
the contact between the tapered surface and the spherical member allows the rocking member to be rockably supported by the supporting member; and
an O-ring for preventing the pressurized gas inside the supporting space from leaking is provided on the internal perimeter of the insertion hole with the O-ring installed in a ring-shaped groove to provide a sidewall surface that contacts the inside of the O-ring.

11. The levitation unit with a tilting function according to any of claims 10, wherein the jetting surface is formed from a porous body.

12. A levitation unit with a tilting function that is provided with a jetting surface from which a pressurized gas is jetted, and that supports a workpiece free of contact with the jetting surface by means of the pressurized gas jetting out from the jetting surface, and
with a supporting member that has a spherical member, on the bottom end of which an axle extending in the vertical direction is provided, the axle being provided with a securing part that is secured to an installation surface, and which also has a supporting member channel that opens at the spherical surface of the spherical member; and is also provided with
a rocking member provided with a jetting part having the jetting surface on its top surface, containing a supporting space for housing the spherical member, with the opening of an insertion hole connecting the interior of the supporting space to the outside provided face down with the axle being inserted into the insertion hole, and a contact area that can contact the bottom area of the spherical surface of the spherical member provided on the inside bottom of the supporting space, and further provided with a rocking member channel that is connected to the jetting part and opens at the surface that forms the supporting space; wherein
the rocking member is provided with an O-ring that is positioned horizontally in a position higher than the center of the spherical surface inside the supporting space and that prevents the pressurized gas from leaking out of the space between the spherical member and the rocking member; and wherein
the contact between the O-ring and the top part of the spherical surface of the spherical member allows the rocking member to be rockably supported by the supporting member.

13. The levitation unit with a tilting function according to any of claims 12, wherein the jetting surface is formed from a porous body.

14. A levitation unit with a tilting function that is provided with a jetting surface from which a pressurized gas is jetted, and that supports a workpiece free of contact with the jetting surface by means of the pressurized gas jetting out from the jetting surface, and
with a rocking member having the jetting surface and a supporting member that supports the rocking member; wherein
a spherical member provided in the supporting member is housed inside a supporting space provided in the rocking member, and
the supporting space is provided internally with a ring-shaped sealing means that seals the space between the internal surface forming the supporting space and an area higher than the center of the spherical surface of the spherical member by contacting both, and that also allows the supporting member to rockably support the rocking member through this contact; and wherein
the supporting member is provided with a supporting member channel that opens at a position higher than the contact area between the spherical member and the sealing means, and the rocking member is provided with a rocking member channel, one end of which is connected to the jetting surface while the other end opens at the internal surface forming the supporting space and is connected to the opening of the supporting member channel via the supporting space.

15. The levitation unit with a tilting function according to any of claims 14, wherein the jetting surface is formed from a porous body.

16. A levitation unit with a tilting function that is provided with a jetting surface from which a pressurized gas is jetted, and that supports a workpiece free of contact with the jetting surface by means of the pressurized gas jetting out from the jetting surface, and
with a rocking member having the jetting surface and a supporting member that supports the rocking member; wherein
a spherical member provided in the rocking member is housed inside a supporting space provided in the supporting member, and
the supporting space is provided internally with a ring-shaped sealing means that seals the space between the internal surface forming the supporting space and an area lower than the center of the spherical surface of the spherical member by contacting both, and that allows the supporting member to support the rocking member through this contact; and wherein
the rocking member is provided with a rocking member channel, one end of which is connected to the jetting surface while the other end opens at a position lower than the contact area between the spherical member and the sealing means, and the supporting member is provided with a supporting member channel that is connected to the other opening of the rocking member channel via the supporting space.

17. The levitation unit with a tilting function according to 16, wherein the jetting surface is formed from a porous body.

18. A levitation device that is provided with a large number of levitation units and that supports a thin plate-shaped workpiece on a non-contact basis by means of a pressurized gas jetting out from the jetting surfaces of the levitation units; wherein
on the four corners or edges of the levitation device, as viewed in a plan view diagram, is provided any of the levitation units with a tilting function described in any of claims 1 through 17 among the multiple levitation units.
